(19) United States
(12) Patent Application Publication
(10) Pub. No.: US 2004/0215660 A1
(43) Pub. Date: Oct. 28, 2004

(54) Image search method and apparatus

(75) Inventor: Kazuyo Ikeda, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/771,293

(22) Filed: Feb. 5, 2004

(30) Foreign Application Priority Data
Feb. 6, 2003 (JP) 2003-029668(PAT.)

(51) Int. Cl. G06F 7/00

(52) U.S. Cl. 707/104.1

(57) ABSTRACT

There is provided an image search apparatus which can display a search result more preferably when a search is made for an image upon designation of a keyword or object, and can efficiently searches for a desired image from the displayed search result. An image feature designation unit (104) designates a feature of a search target image. A candidate image decision unit (105) searches the feature of the partial images on the basis of the designated feature of the image, and determines, as a candidate image, an image which is made to correspond to the partial image obtained on the basis of the search result. A search result display unit (106) displays enlarges the partial image included in the determined candidate image to a predetermined size and displays a reduced image of the candidate image.

### FIELD OF THE INVENTION

The present invention relates to an image search technique of searching for a desired still image, moving image, or the like in a computer, information processing equipment, or the like.

### BACKGROUND OF THE INVENTION

Recently, various kinds of information have been digitized, and the digitized information have been managed by a computer, information processing equipment, or the like. At the advent of JPEG, MPEG-1, MPEG-2, MPEG-4, and the like, image contents such as still images or moving images can be efficiently compressed/coded as digitized information. These image contents have been stored in a large amount and managed in the hard disk of a computer or information processing equipment with an increase in hard disk capacity and a reduction in cost. When a large amount of image contents is stored in a hard disk or the like, it raises a question about how to make a search to find out a desired image from the large amount of image contents.

In general, as a technique of searching for a desired image from a large amount of stored image contents, a method is available, which assigns keywords to the respective image contents in advance and searches for a keyword assigned to images. A technique of displaying the images corresponding to the keyword as a search result on a monitor or the like is used, which allows the operator to visually find out a desired image from the displayed images.

In the present day in which the Internet has been popularized, such a search technique using keywords is also generally used in an image search system which a content provider having a large amount of image contents has prepared on the Internet to broadcast images to consumers.

Likewise, a search system for images present on the respective WWW (World Wide Web) pages provided by a WWW search system also provides a means for searching for images by a similar technique by associating the keywords, obtained from file names of src attributes with img tags in HTML files, character strings of alt attributes, or the like, with images indicated by the file names in the src attributes.

FIG. 7 is a view showing an example of a search operation window in a conventional image search system. As shown in FIG. 7, an image search window 701 is mainly constituted by a search instruction area 702 and search result display area 705. In the search instruction area 702, a keyword input area 703 for inputting a keyword and a search button 704 for issuing a search instruction are displayed. The operator inputs a keyword in the keyword input area 703 by using a keyboard, and clicks the search button 704 with a mouse. With this operation, images associated with the keyword identical to the character string input in the keyword input area 703 are searched out, and thumbnails (reduced images) of the images obtained as a result of the search are displayed in the form of a list in the search result display area 705 in the order of the decreasing similarities of the objects from thumbnails 706 and 707 to the thumbnail 708.

As another search method, the following method is available. Objects are extracted from images by segmenting them using information such as edges and textures. Feature amounts of colors, shapes, and the like of the objects are stored as indexes in a database in correspondence with the images. At the time of a search, partial images of objects corresponding to the above index are selected, and the feature amounts of the objects are compared with each other to obtain a similarity. In this case as well, there is a method of sequentially displaying thumbnails (reduced images) of the images obtained as a search result in the form of a list in the search result display area 705 in the order of thumbnails 706, 707, and 708.

In a moving image search as well, a moving image is segmented at scene changes, and a search is made for a still image as a representative image of each scene by a method similar to that described above, thereby searching for a desired moving image scene.

In the above conventional search method, however, the thumbnail images displayed in the search result display area 705 are images obtained by simply and directly reducing whole still images. Many such reduced images are simply arranged in the search result display area 705. For this reason, when a partial image corresponding to a keyword input for a search, i.e., a partial region of a thumbnail image, is to be visually checked, it is not easy to search for a partial image corresponding to an object corresponding to the keyword. In addition, grasping the details of the partial image corresponding to the object is not easier than searching for it.

FIG. 8 is a view showing an example of a still image registered in an image database. If, for example, the size of a partial image corresponding to a keyword is relatively small in the image, like a partial image 803 corresponding to the “car” shown in FIG. 8, the corresponding partial region is displayed in a smaller size in the search result display area 705. It is therefore not easy to visually find out a partial image corresponding to the keyword input in the keyword input area 703. It is more difficult to grasp the details of the partial image.

Assume that the thumbnail images obtained as a result of a search using a feature amount such as the color or shape of an object are to be displayed in the search result display area 705. In this case as well, if a partial image corresponding the object which is designated at the time of the search is relatively small in the image to be searched, it is not easy to find out a partial image corresponding to the object designated at the time of the search. It is also not easy to grasp the details of the partial image.

Assume that a search is to be made by using a feature amount such as the color or shape of an object. In this case, in particular, since there is no guarantee that a concept representing the meaning of an object designated at the time of a search will reliably match a concept representing a partial image found as a search result, if the detected partial image is relatively small in the thumbnail image, it is not easy to even grasp what it is. In many cases, therefore, it is difficult to search for a desired image.

In addition, as described above, in some cases, it is impossible to grasp a partial image up to the details. When, therefore, candidate images obtained as a search result are displayed in the form of a list, it may be difficult to determine, by comparing partial images in the candidate images which satisfy a search condition, which one of the candidate images is a desired image.

### SUMMARY OF THE INVENTION

The present invention has been proposed to solve the conventional problems, and has as its objects to provide an image search method and apparatus which can display a search result more suitably when images are searched out upon designation of a keyword or object, and efficiently search for a desired image in the displayed search result.

In order to achieve the above object, an image search apparatus according to the present invention comprises image storage means for storing a plurality of images, region information storage means for storing partial images included in the respective images stored in the image storage means in correspondence with the respective images, and region feature storage means for storing features of the partial images stored in the region information storage means in correspondence with the partial images, comprising image feature designation means for designating a feature of a search target image, candidate image determination means for searching features of partial images in the region feature storage means on the basis of the feature of the image which is designated by the image feature designation means, and determining an image which is made to correspond to a partial image obtained on the basis of a search result as a candidate image from the images stored in the image storage means and search result display means for displaying a reduced image of the candidate image determined by the candidate image determination means, wherein the search result display means displays a reduced image of the candidate image upon enlarging the partial image included in the candidate image.

In order to achieve the above object, an image search apparatus according to the present invention comprises image storage means for storing a plurality of images, region information storage means for storing partial images included in the respective images stored in the image storage means in correspondence with the respective images, and region feature storage means for storing features of the partial images stored in the region information storage means in correspondence with the partial images, comprising image feature designation means for designating a feature of a search target image, candidate image determination means for searching features of partial images in the region feature storage means on the basis of the feature of the image which is designated by the image feature designation means, and determining an image which is made to correspond to a plurality of partial images obtained on the basis of a search result as a candidate image from the images stored in the image storage means and

search result display means for displaying a reduced image of the candidate image determined by the candidate image determination means, wherein the search result display means displays a reduced image of the candidate image upon enlarging the plurality of partial images included in the candidate image.

In order to achieve the above object, an image search apparatus according to the present invention comprises image storage means for storing a plurality of images, region information storage means for storing partial images included in the respective images stored in the image storage means in correspondence with the respective images, and region feature storage means for storing features of the partial images stored in the region information storage means in correspondence with the partial images, comprising image feature designation means for designating a feature of a search target image, candidate image determination means for searching features of partial images in the region feature storage means on the basis of the feature of the image which is designated by the image feature designation means, and determining an image which is made to correspond to a partial image obtained on the basis of a search result as a candidate image from the images stored in the image storage means and search result display means for displaying a reduced image of the candidate image determined by the candidate image determination means in a plurality of patterns.

In order to achieve the above object, an image search method for an image search apparatus according to the present invention can be connected to an image storage unit which stores a plurality of images, a region information storage unit which stores partial images included in the respective images stored in the image storage unit in correspondence with the respective images, and a region feature storage unit which stores features of the partial images stored in the region information storage unit in correspondence with the partial images, comprising an image feature designation step of designating a feature of a search target image, a candidate image determination step of searching features of partial images in the region feature storage unit on the basis of the designated feature of the image, and determining an image which is made to correspond to a partial image obtained on the basis of a search result as a candidate image from the images stored in the image storage unit and a search result display step of enlarging the partial image included in the determined candidate image and displaying a reduced image of the candidate image.

In order to achieve the above object, an image search method for an image search apparatus according to the present invention can be connected to an image storage unit which stores a plurality of images, a region information storage unit which stores partial images included in the respective images stored in the image storage unit in correspondence with the respective images, and a region feature storage unit which stores features of the partial images in the region information storage unit in correspondence with the partial images, comprising an image feature designation step of designating a feature of a search target image, a candidate image determination step of searching features of partial images stored in the region feature storage unit on the basis of the designated feature of the image, and determining an image which is made to correspond to a plurality of partial images obtained on the basis of a search result as a candidate image from the images stored in the image storage unit and a search result display step of enlarging the plurality of partial images included in the determined candidate image and displaying a reduced image of the candidate image.

In order to achieve the above object, an image search method for an image search apparatus according to the present invention can be connected to an image storage unit which stores a plurality of images, a region information storage unit which stores partial images included in the respective images stored in the image storage unit in correspondence with the respective images, and a region feature storage unit which stores features of the partial images stored in the region information storage unit in correspondence with the partial images, comprising an image feature designation step of designating a feature of a search target image, a candidate image determination step of searching features of partial images in the region feature storage unit on the basis of the designated feature of the image, and determining an image which is made to correspond to a partial image obtained on the basis of a search result as a candidate image from the images stored in the image storage unit and a search result display step of displaying a reduced image of the determined candidate image in a plurality of patterns.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporates in and constitute a part of the specification, illustrate embodiments of the invention and, together with the description, serve to explain the principle of the invention.

FIG. 1 is a block diagram showing the arrangement of an image search apparatus according to the first embodiment of the present invention;

FIG. 2 is a block diagram showing the connection arrangement of various kinds of equipment for realizing the image search apparatus according to the first embodiment;

FIG. 3 is a conceptual view showing how a control program and the like are supplied from a CD-ROM 205 to a computer system;

FIG. 4 is a view for explaining an example of the arrangement of data stored in a ROM 202 in FIG. 2;

FIG. 5 is a view showing the data arrangement of an image registration program 501, image search program 502, and the like stored in the CD-ROM 205 which is a portable recording medium;

FIG. 6 is a view for explaining an example of the data arrangement on a RAM 203 at the time of execution of a processing program;

FIG. 7 is a view showing an example of a search operation window in a conventional image search system;

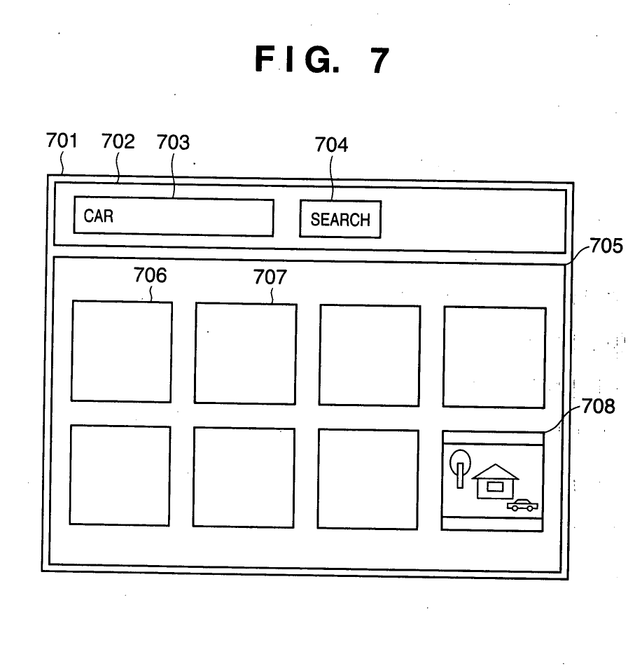

FIG. 8 is a view showing an example of a still image registered in an image database;

FIG. 9 is a view showing an example of the data arrangement of an image database 605 in the first embodiment;

FIG. 10 is a view showing an example of the data arrangement of a region database 606;

FIG. 11 is a view showing an example of the data arrangement of a search condition list 607 in the first embodiment;

FIG. 12 is a view showing an example of the data arrangement of a region comparison buffer 608 which stores the result obtained by comparing the search condition designated in step S401 with the regions in the image extracted in step S402;

FIG. 13 is a view showing an example of the data arrangement of a search result list;

FIG. 14 is a flow chart for explaining an overall sequence in the image search apparatus according to the first embodiment;

FIG. 15 is a flow chart for explaining a detailed processing sequence by an image registration program in the first embodiment;

FIG. 16 is a flow chart for explaining the image registration program and a region selection processing sequence in search condition designation processing;

FIG. 17 is a flow chart for explaining in detail the operation of an image search program in step S104 in FIG. 14;

FIG. 18 is a flow chart for explaining in detail a search condition designation processing sequence in step S401 in the processing by the image search program in FIG. 17;

FIG. 19 is a flow chart for explaining similarity calculation processing in step S404;

FIG. 20 is a flow chart for explaining in detail thumbnail generation processing in step S406;

FIG. 21 is a view showing a window display example on a display 208 which is displayed during image search processing in step S104 in FIG. 14;

FIG. 22 is a view showing a window display example to explain a state wherein an image in a search result display area is selected to perform region selection processing in the image search program;

FIGS. 23A to 23F are views showing window display examples to explain region selection processing;

FIGS. 24A to 24C are views for explaining how an embodiment of thumbnail generation processing is performed;

FIGS. 25A to 25C are views for explaining how another embodiment of thumbnail generation processing is performed;

FIG. 26 is a view for explaining how thumbnail image generation processing is performed when the areas of a plurality of rectangular regions are made uniform;

FIG. 27 is a view for explaining a thumbnail image generated by thumbnail generation processing; and

FIGS. 28A to 28C are views for explaining an embodiment of thumbnail generation processing of generating a plurality of thumbnails with respect to one image.

### DETAILED DESCRIPTION OF THE PREFERRED EMBODIMENTS

An image search apparatus according to an embodiment of the present invention will be described below with reference to the accompanying drawings.

<First Embodiment>

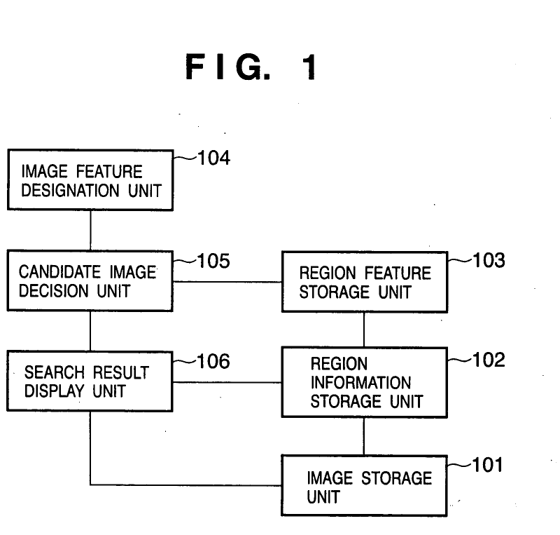

An outline of an image search apparatus according to the first embodiment of the present invention will be described first. FIG. 1 is a block diagram showing the arrangement of the image search apparatus according to the first embodiment of the present invention. Referring to FIG. 1, image contents such as still images and moving images as image search targets are stored in an image storage unit 101. Note that each image data is stored in the image storage unit 101, together with a file name corresponding to the image data. The image storage unit 101 is connected to a region information storage unit 102. The region information storage unit 102 stores information indicating a specific region in each image stored in the image storage unit 101. Note that each information indicating a region is stored in the region information storage unit 102 in correspondence with a corresponding image stored in the image storage unit 101.

The region information storage unit 102 is connected to a region feature storage unit 103. The region feature storage unit 103 stores a feature of each region stored in the region information storage unit 102. Note that a feature of each region is stored in the region feature storage unit 103 in correspondence with information indicating the corresponding region stored in the region information storage unit 102. Such a feature of a region includes, for example, language information such as a keyword representing an object corresponding to the region and image feature information such as the color, shape, or position of the region.

An image feature designation unit 104 is used by an operator or the like to designate a feature of an image to be searched out. Features designated by the operator or the like include, for example, language information (e.g., a character string) such as a keyword and image feature information such as the color, shape, or position of a specific region in an image.

A candidate image decision unit 105 is connected to the region feature storage unit 103 and image feature designation unit 104. The candidate image decision unit 105 compares the feature designated by the image feature designation unit 104 with the features stored in the region feature storage unit 103, and determines images as candidate images, obtained as a result of a search, which include regions corresponding to features identical or similar to the designated feature.

A search result display unit 106 is connected to the image storage unit 101, region information storage unit 102, and candidate image decision unit 105. With regard to the candidate images determined by the candidate image decision unit 105, the search result display unit 106 displays regions (object regions) whose features are determined to be identical or similar to the designated feature or partial images including the regions in an area with a predetermined size. In displaying a region or a partial image including the region, the search result display unit 106 displays the region in a larger size than an image of the region displayed when the entire corresponding image is displayed in an area with a predetermined size. In addition, in displaying the region or the partial image including the region, the search result display unit 106 emphasizes it to allow easy visual recognition.

The details of the image search apparatus according to this embodiment will be described below.

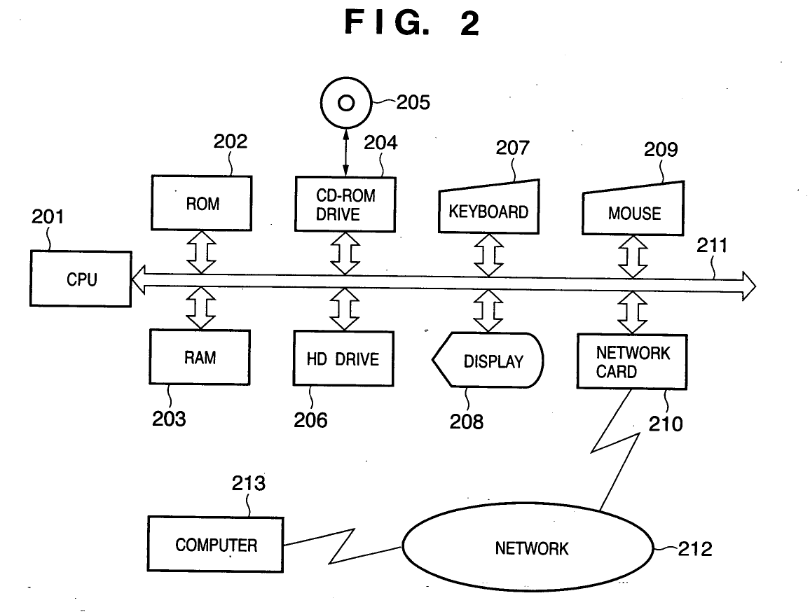

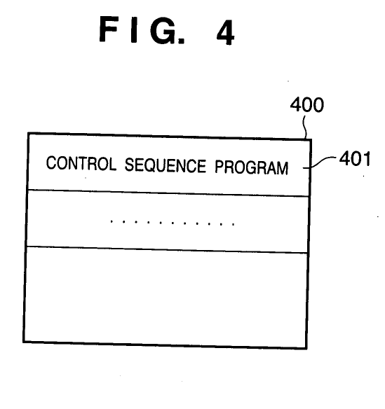

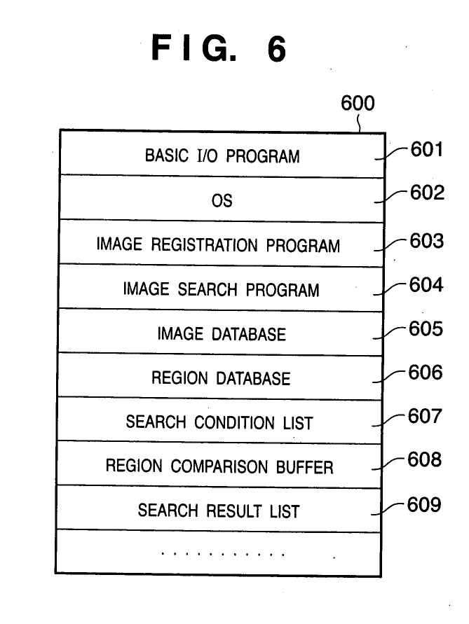

FIG. 2 is a block diagram showing the connection arrangement of various kinds of equipment for implementing the image search apparatus according to the first embodiment. Referring to FIG. 2, a CPU 201 executes various control operations in this apparatus, including the processing to be described below, by executing the control programs stored in a ROM 202 or RAM 203. FIG. 4 is a view for explaining an example of the arrangement of data stored in the ROM 202 in FIG. 2. As shown in FIG. 4, a control sequence program 401 is stored in the ROM 202. FIG. 6 is a view for explaining an example of a data arrangement on the RAM 203 at the time of execution of a processing program. As shown in FIG. 6, the RAM 203 stores an image registration program 603, image search program 604, image database 605, region database 606, search condition list 607, region comparison buffer 608, and search result list 609.

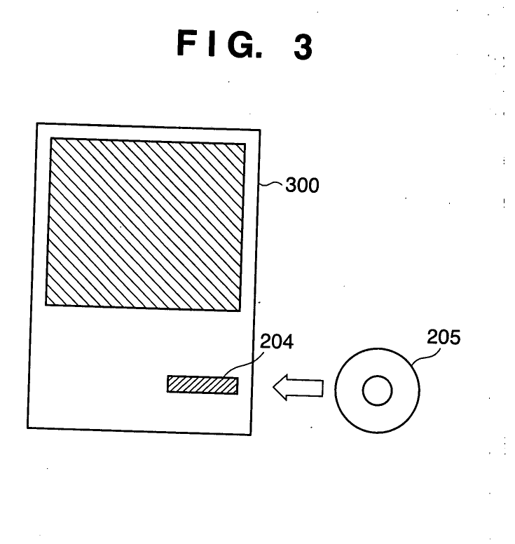

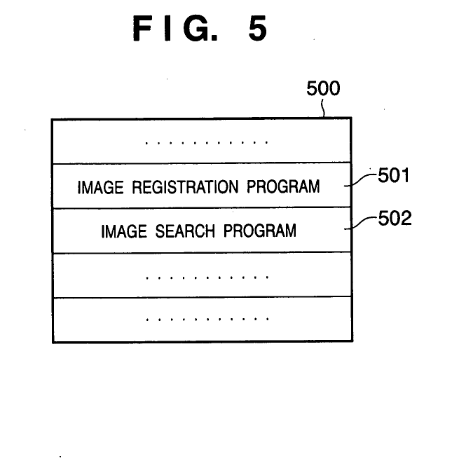

Referring to FIG. 2, a CD-ROM drive 204 reads out control programs and various kinds of data from a CD-ROM 205, and provides them for this image search apparatus. FIG. 3 is a conceptual view showing that a control program and the like are provided from the CD-ROM 205 to the computer system. FIG. 5 is a view showing the data arrangement of an image registration program 501, image search program 502, and the like stored in the CD-ROM 205 which is a portable recording medium.

When the image registration program 501 and image search program 502 are loaded from the CD-ROM 205 into the RAM 203 through the CD-ROM drive 204, the CPU 201 can execute them. That is, the data arrangement on the RAM 203 shown in FIG. 6 indicates a memory map in a state wherein the image registration program 501 and image search program 502 stored in the CD-ROM 205 are loaded into the RAM 203 and can be executed.

In the above program executable state, the image database 605, region database 606, and the like are loaded and initialized on the memory map by a hard disk drive 206, in addition to the image registration program 501 (the image registration program 603 on the memory map) and the image search program 502 (the image search program 604 on the memory map).

Referring to FIG. 2, the hard disk drive 206 provides a large-capacity storage area in this image search apparatus. The control programs stored in the CD-ROM 205 may therefore be installed in the hard disk drive 206 to be loaded into the RAM 203 as needed. A keyboard 207, display 208, mouse 209, and network card 210 communicatively connect the respective components described above to each other through a system bus 211. This image search apparatus can be connected to a network 212 through the network card 210 and can communicate with other computer equipment 213 connected to the network 212.

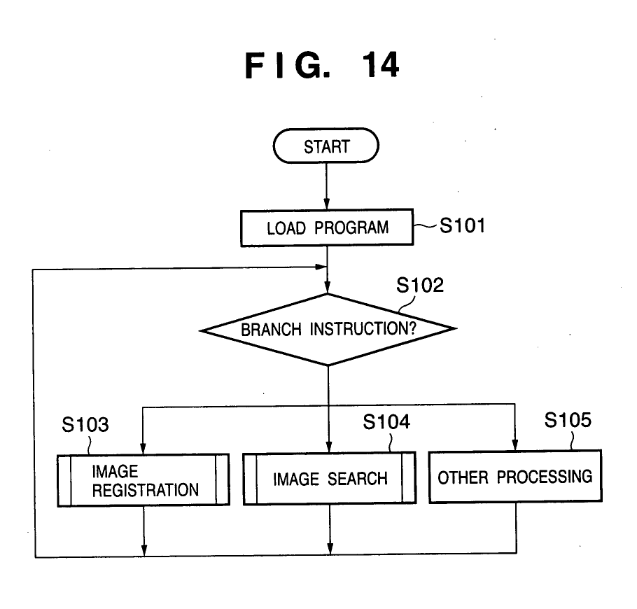

The operation sequence of the image search apparatus having the above arrangement will be described next. FIG. 14 is a flow chart for explaining the overall operation sequence of the image search apparatus according to this embodiment.

First of all, the image registration program 501, image search program 502, and the like stored in the CD-ROM 205 are loaded from the CD-ROM drive 204 into the RAM 203. In addition, the image database 605, region database 606, and the like are loaded from the hard disk drive 206 into the RAM 203. Necessary initialization is then performed (step S101).

The operator then issues an instruction to cause a branch to the subsequent processing with the keyboard 207 or mouse 209 (step S102). If an instruction for “image registration” is issued as a result of this operation, the flow branches to step S103. If an instruction for “image search” is issued, the flow branches to step S104. If an instruction of other processing is issued, the flow branches to step S105.

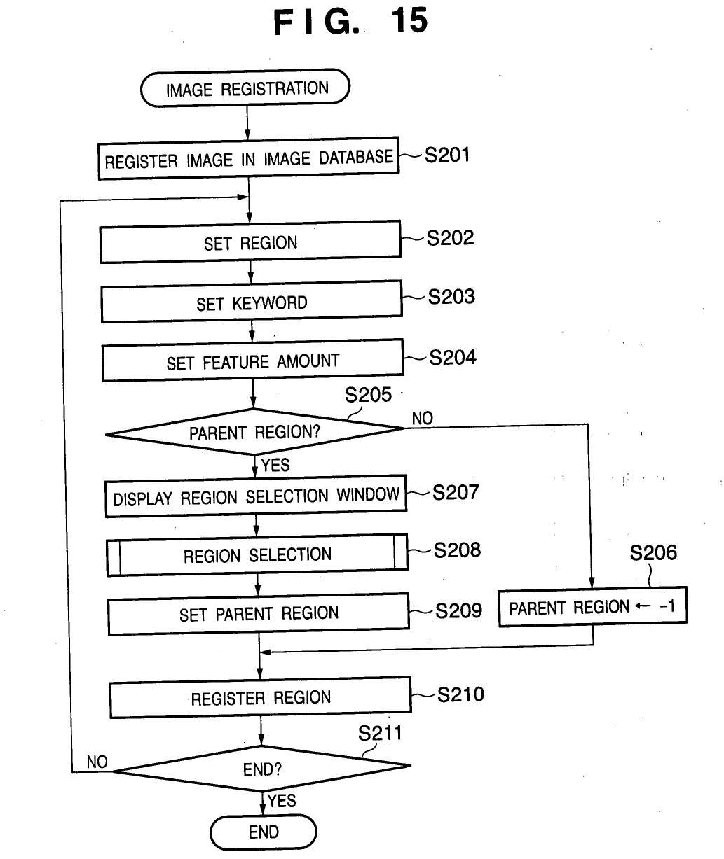

In step S103, the image registration program 603 is activated to register an image in the image database 605 in FIG. 6. In addition, the information of a region in the registered image is registered in the region database 606. Note that the detail processing sequence in step S103 will be described later with reference to FIG. 15.

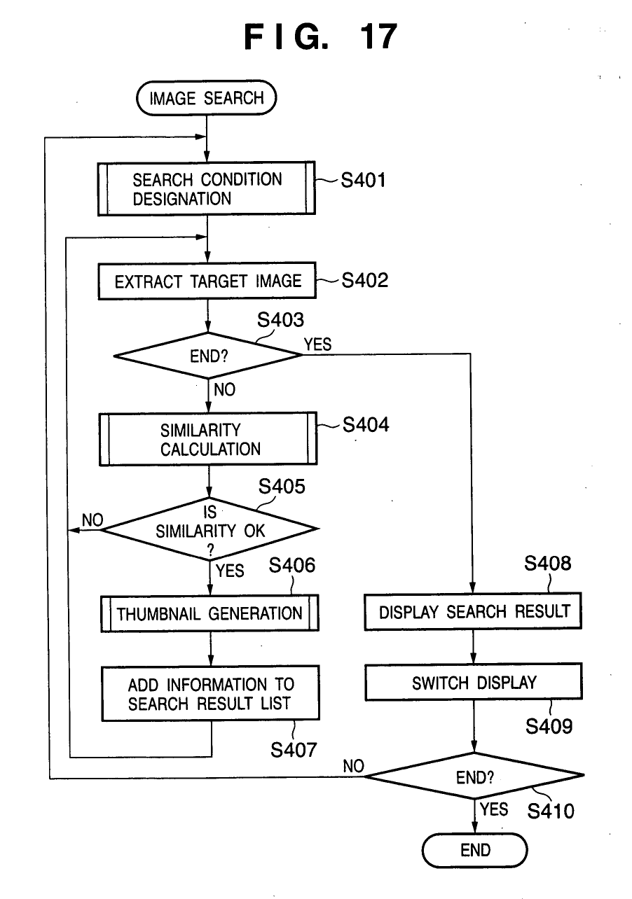

In step S104, the image search program 604 for the execution of an image search is activated to search for an image registered in the image database 605 by referring to the region database 606 in accordance with operation by the operator. The detailed processing sequence in step S105 will be described in later with reference to FIG. 17.

Step S105 is the step of performing processing other than image registration and image search and is not directly associated with the embodiment of the present invention.

Processing by the image registration program 501 (the image registration program 603 on the memory map) executed in step S103 will be described. FIG. 15 is a flow chart for explaining the detailed processing sequence by the image registration program in this embodiment.

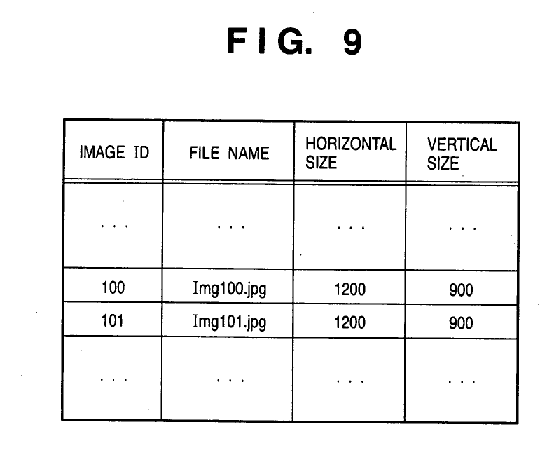

As shown in FIG. 15, first of all, the image designated by the operator is registered in the image database 605 (step S201). FIG. 9 is a view showing an example of the data arrangement in the image database 605 in this embodiment. As shown in FIG. 9, “image ID” for identifying an image, “file name” indicating a file in which image data is stored, “horizontal size” indicating the number of pixels of the image in the horizontal direction, and “vertical size” indicating the number of pixels of the image in the vertical direction are stored as information associated with each image (to be referred to as “image information” hereinafter) in the image database 605 in correspondence with each other. Assume that the respective pieces of image information are sorted in ascending order according to the image IDs.

For example, an image with a horizontal size of 1,200, a vertical size of 900, and a file name of Img100.jpg is stored as an image having an image ID value of 100 in the image database 605 shown in FIG. 9.

In step S201, the operator designates the file name of an image to be registered. A horizontal size and vertical size are then obtained from the image data obtained from the designated file name, and an unused image ID value is generated as an image ID. These pieces of image information are added to the image database 605 so as to be sorted in ascending order according to the image ID. Note that such a processing sequence is processing generally performed in an image search apparatus which handles a similar kind of image database, and is known. Therefore, a further detailed description will be omitted.

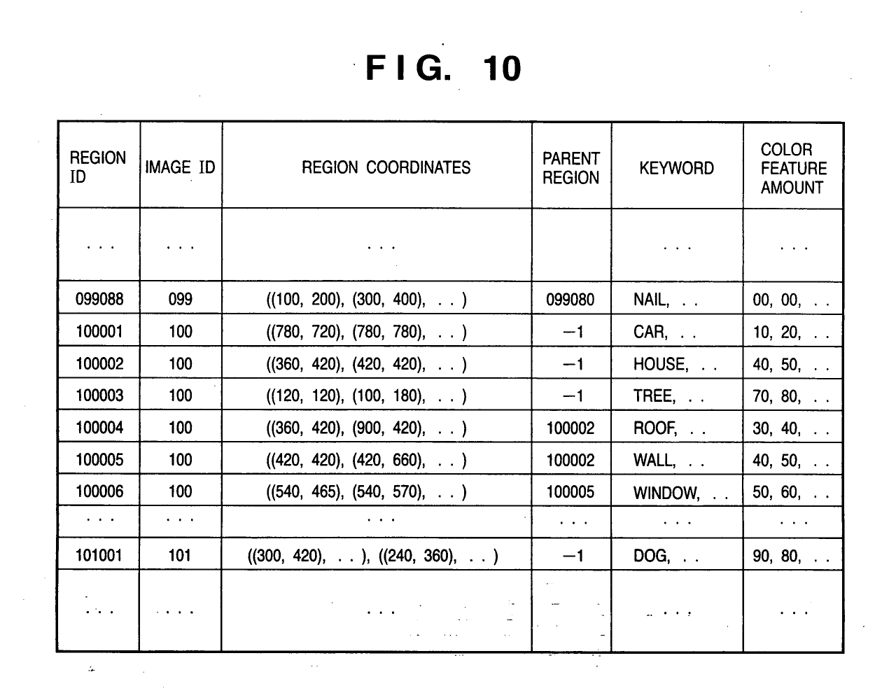

Referring to FIG. 15, the processing from step S202 to step S211 is the processing of registering the information of a region in the image registered in step S201 into the region database 606. FIG. 10 is a view showing an example of the data arrangement in the region database 606. As shown in FIG. 10, “region ID” for identifying a region, “image ID” for indicating an image to which the region belongs, “region coordinates” representing the location of the region in the image, “parent region” indicating a parent region to which a target region belongs, “keyword” expressing the contents of the region by a character string, and “color feature amount” representing the color feature of the region are stored as information associated with each region (to be referred to as “region information” hereinafter) in the region database 606. Assume that the respective pieces of region information are sorted in ascending order according to the region IDs.

In this embodiment, as “region ID”, the value obtained by combining a three-digit value, set as three low-order digits, for identifying a region in the same image and the image ID value of the image to which the region belongs as upper-order digits is used. This allows pieces of region information associated with the same image to be complied into one group in the region database 606, as shown in FIG. 10. Note that the number of digits of an image ID may be other than three.

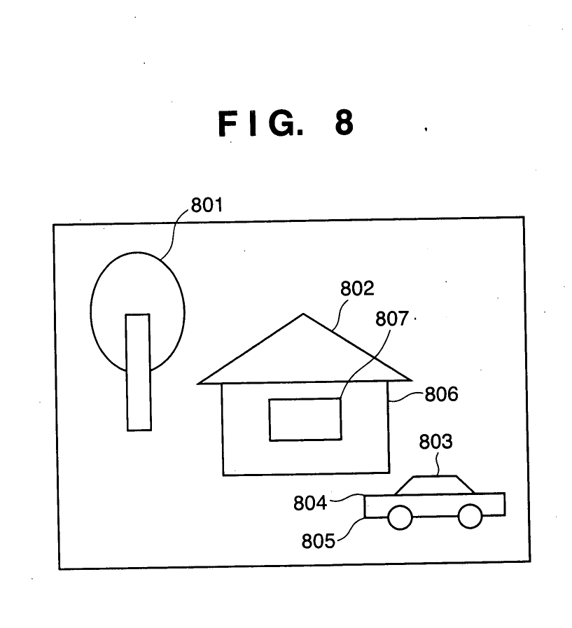

In addition, “region coordinates” express a target region, which is regarded as a polygon, by a list of the coordinates of the vertexes of the polygon. Each coordinate pair is expressed by a coordinate system in which an upper left point of a target image is set as an origin, and the x- and y-coordinate axes are respectively set in the rightward and downward directions. For example, the region coordinates of a partial image 803 corresponding to “car” are given as ((780, 720), (780, 780), . . . ) as region information corresponding to the region ID “100001” in FIG. 10. In this case, the coordinates of a vertex 804 of the partial image 803 shown in FIG. 8 are (780, 720), and the coordinates of a vertex 805 correspond to (780, 780).

In some image, since a person stands in front of a dog, the region of the dog is divided into two regions. In order to cope with a case wherein a region which should be a single region is divided by another region, a plurality of regions can be stored in “region coordinates” in this embodiment. For example, as shown in FIG. 10, ((300, 420), . . . ), ((240, 360), . . . ) are set in the region coordinate field corresponding to the region ID “101001”. This indicates that this region is constituted by two regions, i.e., the region expressed by ((300, 420), . . . ) and the region expressed by ((240, 360), . . . )

“Parent region” shown in FIG. 10 indicates the parent/child relationship or inclusive relationship between regions. For example, the region of a partial image 802 corresponding to “house” is constituted by the two regions of a partial image 806 corresponding to “roof” and “wall” and a partial image 807 corresponding to “window”. The region of the partial image 807 corresponding to “window” is included in the region of the partial image 806 corresponding to “roof” and “wall”. In other words, the parent region of the region of the partial image 807 corresponding to “window” is the region of the partial image 806 corresponding to “roof” and “wall”. The parent region of the region of the partial image 806 corresponding to “roof” and “wall” is the partial image 802 corresponding to the “house”.

In the region database 606 shown in FIG. 10, these relationships are shown in “parent region”. For example, in the parent region field of the partial image 807 corresponding to “window” indicated by the region ID “100006”, the region ID “100005” corresponding to “wall” of the partial image 806 is stored. In the parent region field of the region corresponding to the partial image 806 in which “wall” indicated by the region ID “100005” is included, the region ID “100002” corresponding to the partial image 802 corresponding to “house” is stored. Note that since there is no parent region of the partial image 802 corresponding to “house”, the invalid value “−1” is stored as a region ID in the parent region field corresponding to the region ID “100002”.

A character string such as a keyword which expresses the contents of a target region is stored in “keyword”. Such a character string need not be formed by one word, and a keyword can be expressed by a natural sentence. A plurality of contents can be stored in “keyword”. In this case, the contents can be separated by delimiting character strings expressing the contents with “,”.

As the color feature amount of the region indicated by “region coordinates”, a color histogram is stored in “color feature amount”. A color histogram can be obtained by totalizing the colors of the respective pixels contained in the region indicated by “region coordinates” in the quantum box obtained as a result of uniformly quantizing an RGB color space with three bits for each color, and normalizing the resultant data such that the sum of histogram frequencies become 1,000. The values of the respective quantum boxes of histograms obtained as a result of this processing are so stored in “color feature amount” so as to be delimited with “,” and arranged in a predetermined order.

A sequence for registering a region in the image, which has been registered in step S201, in the region database 606 described above will be descried below with reference to steps S202 to S211.

First of all, a region to be registered in the region database 606 is set (step S202). In this region setting processing, the image registered in step S201 is displayed in a window in the display 208, and the operator designates the vertexes of a polygon by pointing the vertexes of the regions to be registered with the mouse cursor using the mouse 209 and clicking the vertexes one by one. Finally, by clicking the vertex designated at first, a polygonal region defined by connecting the designated vertexes with straight lines can be set. When a plurality of regions are to be designated, another polygonal region can be set by performing the same operation as described above. The list of set coordinates coincides with the contents stored in “region coordinates” of the region information in FIG. 10. When the operator finishes setting the region to be registered, the flow advances to step S203 in accordance with a setting end instruction by the operator.

Step S203 is the processing of setting a content to be stored in “keyword” with respect to the region set in step S202. This keyword setting processing is performed by inputting a character string stored in “keyword” from the keyboard 207. If there are a plurality of contents to be set, they can be input while being delimited with “,” input from the keyboard 207. When the setting is complete, the flow advances to step S204 in accordance with a setting end instruction from the operator.

Step S204 is the feature amount setting processing of setting a content to be stored in “color feature amount” of the region information with respect to the region set in step S202. The manner of obtaining a content to be stored in “color feature amount” is the same as that described in the description of the region database 606 with reference to FIG. 10. This content can be automatically obtained without the mediacy of the operator. When this feature amount setting processing is complete, the flow advances to step S205.

In step S205, a branch occurs to the subsequent processing depending on whether any parent region exists with respect to the region set in step S202. If the operator determines that there is no parent region (No), the flow advances to step S206. If the operator determines that there is a parent region (Yes), the flow advances to step S207. In general, in the initial stage of registration of a region, no parent region has often not been registered. In such a case, the flow advances to step S206. If a parent region has already been registered, the flow advances to step S207. In order to use such a region registration method, therefore, a parent region must be registered before child regions.

Step S206 is the processing to be performed when no parent region exists. In this processing, “−1” is set as a value of “parent region” of the region information, as shown in FIG. 10. When the processing is complete, the flow advances to step S210.

In step S207, a region selection window for the selection of a region is displayed on the display 208 to allow selection of a parent region in step S208. In this region selection window, the image registered in step S201 is displayed. When the processing is complete, the flow advances to step S208.

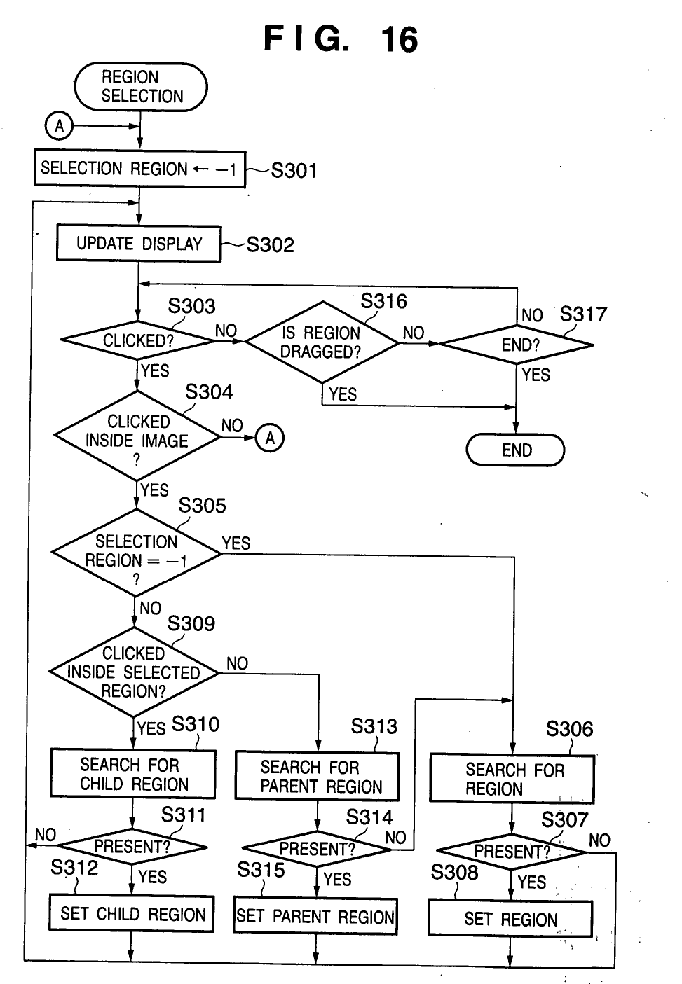

Step S208 is the region selection processing of selecting a region serving as a parent region which has already been registered in the region database 606. The region ID of the parent region can be obtained from the region information of the selected parent region. The details of the region selection processing will be described later with reference to FIG. 16. When the processing is complete, the flow advances to step S209.

In step S209, the region ID of the parent region obtained in step S208 is set as a value of “parent region” of the region information. When the processing is complete, the flow advances to step S210.

Step S210 is the processing of registering the set region in the region database 606 on the basis of the region information set in steps S202 to S209. With the processing from step S202 to step S209, the region information constituted by “region coordinates”, “keyword”, “color feature amount”, and “parent region” is set. In this case, as “image ID” of the region information, the image ID value obtained when the image was registered in the image database 605 in step S201 is used. A value other than the region ID of the region information which is registered in the region database 606 is generated by using this image ID and set as “region ID”. The obtained region information is registered such that the region ID values are sorted in ascending order in the region database 606, as shown in FIG. 10. When the processing in step S210 is complete, the flow advances to step S211.

In step S211, a branch occurs to the subsequent processing depending on whether a region is to be continuously registered. If a region is to be continuously registered (No), the flow returns to step S202 to perform the above processing. If region registration is to be ended (Yes), the image registration program is terminated.

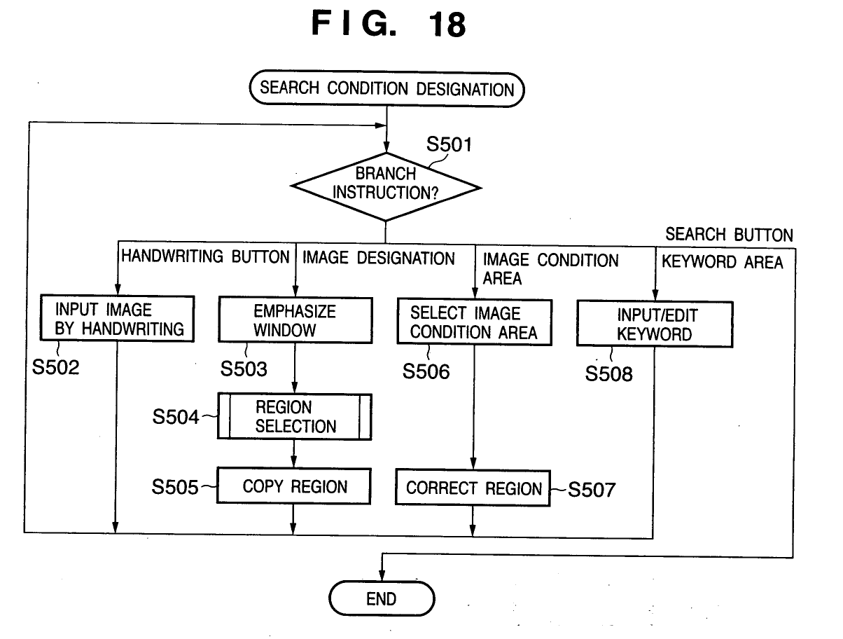

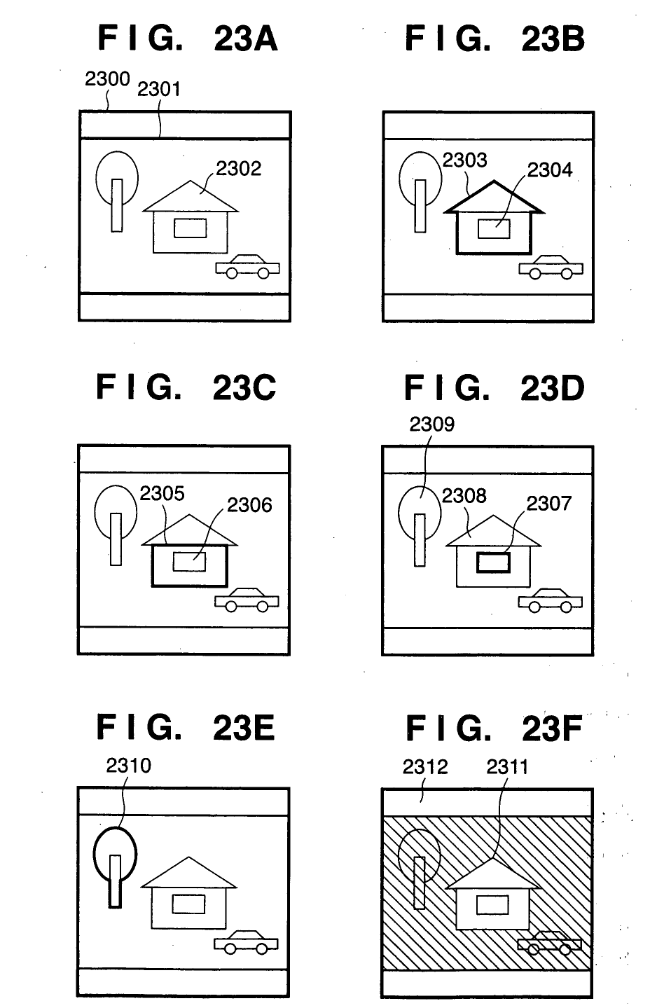

“Region selection processing” performed in step S208 in FIG. 15 and in step S504 in FIG. 18 (to be described later) will be described in detail next with reference to FIGS. 16 and 23A to 23F. Assume that the region database is in the state shown in FIG. 10. FIG. 16 is a flow chart for explaining a sequence for region selection processing in the image registration program and search condition designation processing. FIGS. 23A to 23F are views each showing a window display example to explain region selection processing.

In the region selection processing, a region is selected by using the mouse 209 in a region selection window 2300 like the one shown in FIG. 23A. The region selection window 2300 shown in FIG. 23A displays an image 2301 as a region selection target. In this case, the region selection window 2300 in step S208 in the flow chart shown in FIG. 15 is the window displayed in step S207, and the region selection window 2300 in step S504 is the window emphasized in step S503.

First of all, by storing the region ID of the selected region in the region database 606 shown in FIG. 6, “−1” is stored as an initial value in “selected region” indicating the selected region (step S301). If “−1” is stored in “selected region”, it is regarded that the entire image is selected.

The display in the region selection window 2300 is then updated (step S302). If, for example, the region 802 of “house” in FIG. 8 is selected, the contour of the selected region is indicated by thick lines as indicated by reference numeral 2303 in FIG. 23B to allow a visual check on the region indicated by “selected region”. According to another method, as indicated by reference numeral 2311 in FIG. 23F, the selected region is displayed in a normal way, while the regions other than the selected region can be displayed in a display form different from that for the selected region. For example, in such regions, the pixels of an image to be displayed are decimated by replacing alternate dots with black dots.

The contour of a selected region or the boundary between a selected region and an unselected region can be easily obtained by connecting the coordinates the region in “region coordinates” in the region database 606 with straight lines in the case of the region selection in step S208, or by connecting the coordinates of the region in “region coordinates” in the search result list 609 in the case of the region selection in step S504. If “−1” is stored in “selected region”, since it indicates that the entire image is selected, the outer frame of the image is displayed by thick lines, as indicated by reference numeral 2301 in FIG. 23A.

In step S303, a branch occurs to the subsequent processing depending on whether one point pointed by the mouse cursor in the selection region window is clicked with the mouse 209. If the point is clicked (Yes), the flow advances to step S304. If the point is not clicked (No), the flow advances to step S316.

In step S304, a branch further occurs to the subsequent processing depending on whether the clicked position pointed by the mouse cursor is inside the image indicated by reference numeral 2301 in FIG. 23A in the region selection window. If the position pointed by the mouse cursor is inside the image (Yes), the flow advances to step S305. If the position pointed by the mouse cursor is outside the image (No) indicated by reference numeral 2312 in FIG. 23F, the flow returns to step S301 to shift the entire image to the selected state. If a position outside the image is selected in the state shown in FIG. 23B, the state shown in FIG. 23A is set through the processing in steps S301 and S302.

In step S305, a branch occurs to the subsequent processing depending on the value of “selected region”. If the value of “selected region” is −1 (Yes), it is determined that the entire image is selected, and the flow advances to step S306. If the value of “selected region” is not −1 (No), it is determined that a specific region is selected, and the flow advances to step S309.

In step S306, the image 2301 as a region selection target is searched for a region which includes the position clicked in step S303 and has no parent region. In the region selection processing in step S208, the image ID of the image serving as a search range is the image ID of the image registered in step S201. In the region selection processing in step S504, this image ID is the image ID of the image emphasized in step S503. The image ID of the image emphasized in step S503 can be obtained from the search result list 609 described later. The region database 606 is then searched for the region ID of a region which has this image ID and the polygonal region stored in “region coordinates” including the clicked position (coordinates) and has −1 as the value of “parent region”.

In this case, whether “region coordinates” corresponding to the region ID include the clicked position (coordinates) can be checked by searching the region database 606 and using “region coordinates” in the case of the region selection processing in step S208 or when the entire image is displayed by a switching button 2110 in step S503. If the thumbnail images generated in step S406 are displayed in step S503, the above decision can be made by searching the search result list 609 and using “region coordinates”, and a corresponding region ID can be obtained.

In step S307, a branch occurs to the subsequent processing depending on whether a region for which a search was made in step S306 is found. If such a region is found (Yes), the flow advances to step S308. If no such region is found (No), the flow returns to step S302.

In step S308, the region ID value corresponding to the region found in step S306 is stored in “selected region” to set a child region. When the processing is complete, the flow advances to step S302.

If, for example, the position indicated by reference numeral 2302 is clicked in the state shown in FIG. 23A after the processing in step S302, the flow advances to step S306 through the processing in steps S304 and S305. In step S306, when the region database 606 shown in FIG. 10 is searched., the house corresponding to the region ID “100002” is selected instead of the roof corresponding to the region ID “100004”. The state shown in FIG. 23B is then set through steps S307, S308, and S302. Consequently, as indicated by reference numeral 2303, the contour of the house is displayed by thick lines.

In step S309, a branch occurs to the subsequent processing depending on whether the position (coordinates) pointed by the clicked mouse cursor is included in the region corresponding to the region ID stored in “selected region”. Whether the position (coordinates) pointed by the clicked mouse cursor is included in the region corresponding to the region ID stored in “selected region” can be easily determined by comparing the corresponding coordinates with the coordinates of the polygon stored in “region coordinates” in the region database 606 which corresponds to this region ID in the case of the region selection processing in step S208 or when the entire image is displayed by the switching button 2110 in step S503.

If the thumbnail images generated in step S406 are displayed in step S503, the above decision can be easily made by comparing the corresponding coordinates with the coordinates of the polygon corresponding to the target region ID stored in “region coordinate” in the search result list 609. If the position is included in the selected region (Yes), the flow advances to step S310. If the position is not included in the selected region (No), the flow advances to step S313.

In step S310, the region database 606 is searched for a child region of the region which includes the position clicked in step S303 and corresponds to the region ID stored in “selected region”. The region information as a search range is region information having a region ID in “parent region” which is identical to “selected region”. The region information in the region database 606 is then searched for region information having a polygonal region which includes the clicked position (coordinates) and is stored in “region coordinates”.

If the thumbnail images generated in step S406 are displayed in step S503, the coordinates clicked in step S303 are converted into coordinates on the image stored in the image database 605 from the relationship between the coordinates of the polygon in “region coordinates” in the search result list 609 which correspond to the region ID stored in “selected region” and “region coordinates” in the region database 606 which correspond to this region ID before it is determined whether the clicked position (coordinates) is included. Whether the clicked position (coordinates) is included can be easily determined by comparing the clicked coordinates with the coordinates of the polygon which are stored in “region coordinates” in the region database 606.

In step S311, a branch occurs to the subsequent processing depending on whether region information for which a search was made in step S310 is found. If such region information is found (Yes), the flow advances to step S312. If no such region information is found (No), the flow advances to step S302.

In step S312, the value of “region ID” of the region information of a child region of “selected region” found in step S310 is stored in “selected region”. When this processing is complete, the flow returns to step S302.

If, for example, the position indicated by reference numeral 2304 is clicked in the state shown in FIG. 23B after step S302, the flow advances to step S310 through steps S303, S304, S305, and S309. In step S310, as a result of searching the region database 606 shown in FIG. 10, the wall corresponding to the region ID “100005” is selected instead of the window corresponding to the region ID “100006”. In addition, the state shown in FIG. 23C is set through steps S311, S312, and S302, and the contour of the wall is displayed by thick lines, as indicated by reference numeral 2305.

In step S313, a search is made for a parent region including the position clicked in step S303 by tracing the parent region of the region corresponding to the region ID stored in “selected region”. When the thumbnail images generated in step S406 are displayed before the search, the coordinates clicked in step S303 are converted into coordinates on the image stored in the image database 605 from the relationship between the coordinates of the polygon in “region coordinates” in the search result list 609 which correspond to the region ID stored in “selected region” and “region coordinates” of this region ID in the region database 606.

Subsequently, “parent region” of the region information having a region ID identical to the value stored in “selected region” is set as a target parent region in the region database 606, and it is determined whether the polygonal region stored in “region coordinates” of the region information which has this region ID value as “region ID” includes the clicked coordinates. If the coordinates are not included in the target parent region, and the target parent region further has a parent region, i.e., “parent region) of the region information of the target parent region is not “−1”, “parent region” of the region information of the target parent region is set as a target parent region, and a search is made for a parent region including clicked coordinates until there is no parent region.

In step S314, a branch occurs to the subsequent processing depending on the result of the search in step S313. If a parent region including the clicked position is found (Yes), the flow advances to step S315. If no parent region is found (No), the flow advances to step S306.

If the position indicated by reference numeral 2309 is clicked in the state shown in FIG. 23D after step S302, the flow advances to step S313 through steps S303, S304, S305, and S309. If it is determined in step S313 that no parent region is found, the flow advances to step S306 through step S314. In step S306, as a result of searching the region database 606 shown in FIG. 10, the tree corresponding to the region ID “100003” is selected. Thereafter, the state shown in FIG. 23E is set through steps S311, S312, and S302. As indicated by reference numeral 2310, the contour of the tree is displayed by thick lines.

In step S315, the value of “region ID” of the region information of the parent region found in step S313 is set in “selected region”. When the processing is complete, the flow advances to step S302.

If, for example, the position indicated by reference numeral 2308 is clicked in the state shown in FIG. 23D after step S302, the flow advances to step S313 through steps S303, S304, S305, and S309. In step S313, the house corresponding to the region ID “100002” is searched out as a parent region. The state shown in FIG. 23B is set through steps S314, S315, and S302, and the contour of the house is displayed by thick lines, as indicated by reference numeral 2303.

In step S316, a branch occurs to the subsequent processing depending on whether the mouse cursor is placed on the region corresponding to “selected region”, and the region corresponding “selected region” is dragged outside the region selection window. If the region is dragged (Yes), the region selection processing is terminated. Otherwise (No), the flow advances to step S317.

In step S317, a branch occurs to the subsequent processing depending on whether the region selection processing is terminated in accordance with an instruction from the operator. If the region selection processing is to be continued (No), the flow returns to step S303. If an instruction to terminate the region selection processing is issued (Yes), the region selection processing is terminated.

Image search processing by an image search program (the image search program 502 in FIG. 5 or the image search program 604 in FIG. 6) in step S104 in FIG. 14 will be described next.

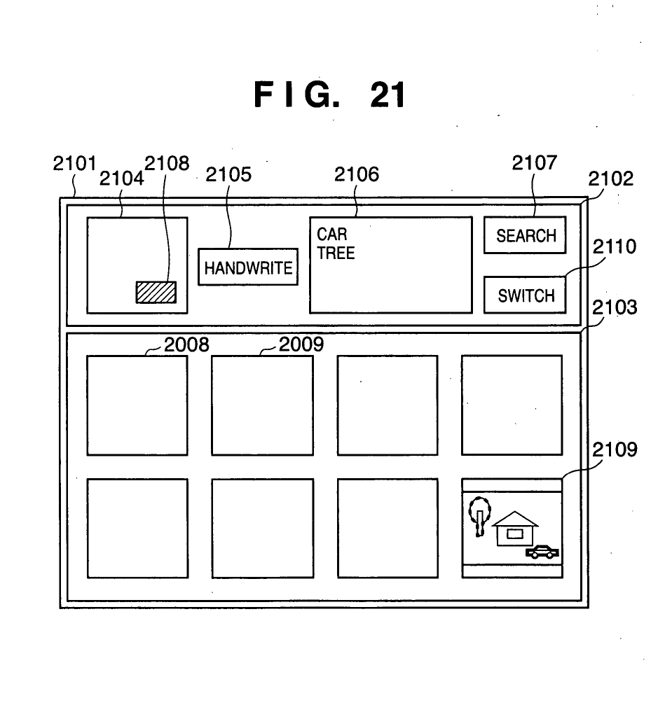

FIG. 21 is a view showing a window display example on the display 208 during the image search processing in step S104 in FIG. 14. Referring to FIG. 21, the area denoted by reference numeral 2102 is a search instruction area for various instructions for a search, and the area denoted by reference numeral 2103 is a search result display area for displaying a search result.

The following are displayed in the search instruction area 2102: an image condition area 2104 for setting a feature of a desired image; a keyword area 2106 for setting a keyword for the desired image; a handwriting button 2105 which issues an instruction to input a feature of the image by handwriting; a search button 2107 which issues an instruction to search for an image which satisfies the conditions input in the image condition area 2104 and keyword area 2106; and the switching button 2110 for switching the display forms of search results to be displayed in the search result display area 2103.

In the search result display area 2103, a list of thumbnails of the images obtained as a result of a search is displayed as indicated by reference numerals 2008 and 2009. Note that the thumbnail images 2008 and 2009 are thumbnails of the images obtained as a result of the search.

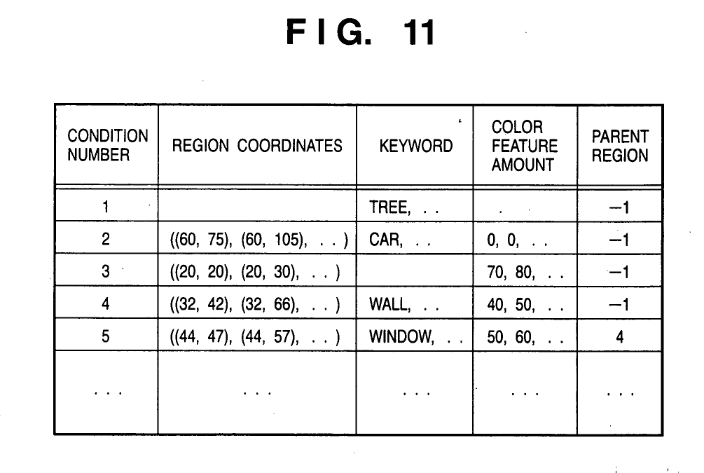

FIG. 17 is a flow chart for explaining in detail the operation of the image search program in step S104 in FIG. 14. First of all, search condition setting processing is performed to set a condition for a search for a desired image (step S401). With this processing, the search condition list 607 shown in FIG. 6 is generated. The details of this search condition setting processing and search condition list 607 will be described later with reference to FIGS. 18 and 11.

Images to be compared with the search condition set in step S401 are extracted from the image database 605 one by one (step S402). More specifically, the values in “image ID” are sequentially extracted one by one from the start of the image database 605. If a target image can be extracted (No in step S403), the flow advances to step S404. If all images are extracted (Yes in step S403), the flow advances to step S408 through step S403.

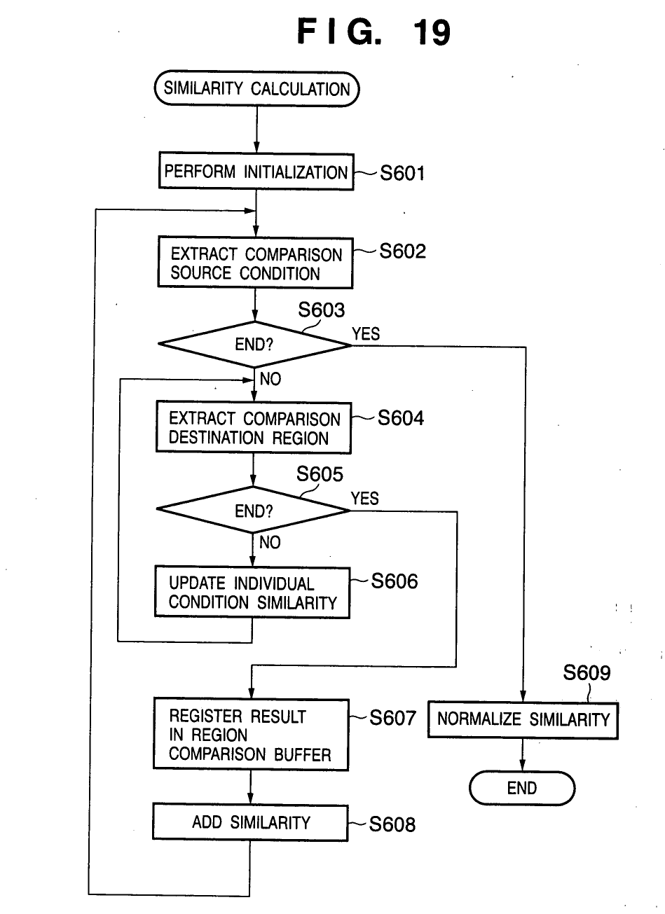

Step S404 is similarity calculation processing of calculating the similarity between each image extracted in step S402 and the search condition set in step S401. With this processing, the region database 606 is referred to on the basis of the image ID extracted in step S402, and computation is performed by collating with the search condition list 607 to generate the region comparison buffer 608, thereby obtaining the similarity with the image extracted in step S402. Note that processing associated with this similarity calculation will be described in detail later with reference to FIG. 19.

In step S405, a branch occurs to the subsequent processing depending on whether the similarity obtained in step S404 is higher than a predetermined threshold. If the similarity is higher than the predetermined threshold (Yes), it is determined that the image extracted in step S402 satisfies the search condition set in step S401, and the flow advances to step S406. If the similarity is lower than the predetermined threshold (No), it is determined that the image extracted in step S402 has not satisfied the search condition set in step S401, and the flow advances to step S402.

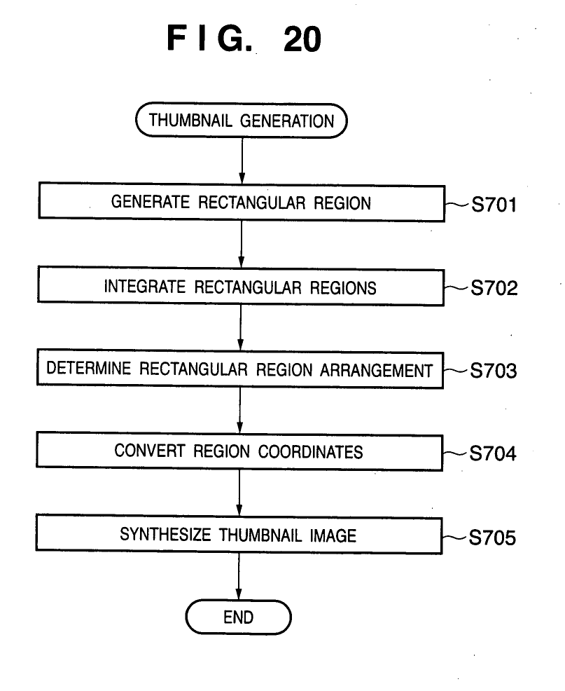

In step S406, thumbnail generation processing of generating thumbnail images of the images obtained as a search result which are displayed in the search result display area 2103 is performed. In this processing, thumbnail images are generated by using the image database 605, region database 606, and region comparison buffer 608, and “region coordinates” for representing each region in the thumbnail image corresponding to each condition in the search condition list 607 are obtained. This processing will be described in detail later with reference to FIG. 20.

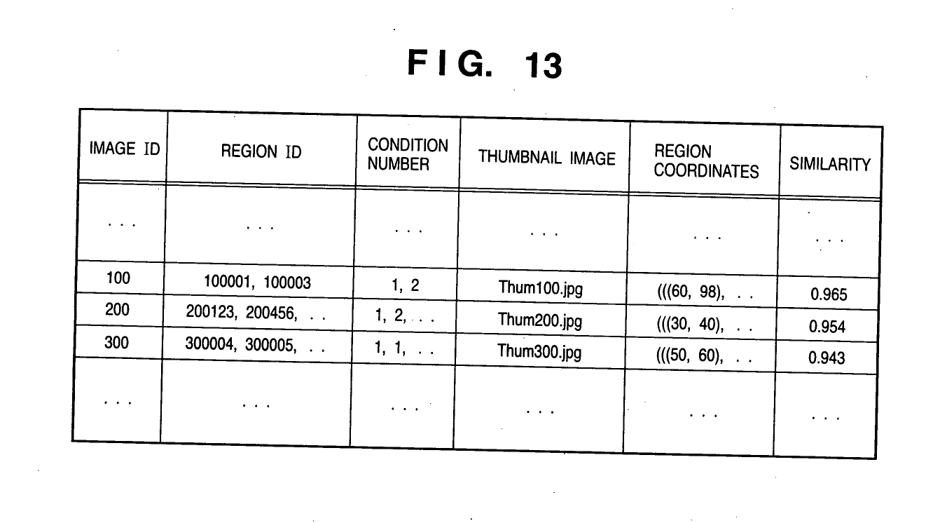

Step S407 is the processing of adding information about the image which satisfies the condition set in step S401 to the search result list 609. FIG. 13 is a view showing an example of the data arrangement of the search result list. As shown in FIG. 13, the information about the image which satisfies the condition set in control sequence program 401 (to be referred to as “search result information” hereinafter) is constituted by “image ID”, “region ID”, “condition number”, “thumbnail image”, “region coordinates”, and “similarity”.

First of all, “image ID” is the image ID of the image extracted in step S402. “Region ID” is a region ID in the region database 606 which corresponds to a region in the image which satisfies each condition in the search condition list 607, and can be obtained from the region ID which is generated in step S404 and stored in the region comparison buffer 608. If a plurality of region IDs are present, they are basically delimited with “,” and stored in the order in which they are stored in the region comparison buffer 608. If a plurality of identical regions are present in the region comparison buffer 608, only one region is stored, and a condition number which exhibits the highest individual condition similarity is selected as a condition number corresponding to the region.

In addition, the number of a condition which “region ID” satisfies is stored in “condition number”, and can be obtained from the region comparison buffer 608. The file name of the thumbnail image generated in step S406 is stored in “thumbnail image”. In addition, the coordinates of the vertexes of a polygon representing the region stored in “region ID” in the thumbnail image generated in step S406 are stored in “region coordinates”.

An expression for one region in “region coordinates” is the same for region coordinates in the region database 606. Since regions corresponding to a plurality of region IDs are stored in “region coordinates” in the search result list 609, information about the regions corresponding to the respective region IDs is delimited with “,” and stored, and the delimited pieces of information are stored in the same order as the region IDs stored in “region ID”. The similarity obtained in step S404 is stored in “similarity”. In step S407, these pieces of search result information are added to the end of the search result list 609. When the above processing is complete, the flow advances to step S402.

Step S408 is the processing of displaying a search result on the display 208. Images indicated by “thumbnail image” are sequentially displayed from the start of the search result list 609 from the upper left to the right in the search result display area 2103 in FIG. 21. In addition, the color of the keyword displayed in the keyword area 2106 in the search instruction area 2102 is changed. As will be described later, in thumbnail generation processing in step S406, the contours of the respective regions satisfying the respective conditions in the search condition list 607 generated in step S401 are edged with thick lines in different colors determined for the respective condition numbers. In the thumbnail image denoted by reference numeral 2109 in FIG. 21, regions are expressed by “contour emphasis with dots”, “no contour emphasis”, and “contour emphasis with thick lines” instead of colors. Such an expression can also be used.

In the same manner as described above, the characters of keywords are displayed in the keyword area 2106 in colors determined for the respective condition numbers. Alternatively, the character strings of the keywords may be edged with thick lines in different colors determined for the respective condition numbers. In addition, the colors of the thick lines with which the respective regions displayed in the image condition area 2104 in the search instruction area 2102 are edged are changed or such colors are added. As in the case of keywords, the respective regions displayed in the image condition area 2104 are edged with thick lines in colors determined for the respective condition numbers.

As will be described later, some region displayed in the image condition area 2104 may have already been edged with thick lines in a specific color. In this case, the color of the edging thick lines is changed. Otherwise, edging thick lines are added. This makes it possible to easily grasp the correspondence between a condition as a feature of each image, a condition as a keyword, and a condition with which a region in a search result satisfies. The user can therefore easily check the search result. When the processing is complete, the flow advances to step S409.

Step S409 is the processing of switching displays for a check on a search result. When the switching button 2110 in FIG. 21 is clicked with the mouse 209, the thumbnails displayed in the search result display area 2103 can be switched from the images represented by “thumbnail image” in the search result list 609 to the reduced images of the images indicated by “file name” in the image database 605. When the switching button 2110 is clicked again, the thumbnails displayed in the search result display area 2103 are returned to the images represented by “thumbnail image” in the search result list 609.

Subsequently, the thick lines of the region corresponding to condition number 1 in the region comparison buffer 608 are blinked. In addition, the thick lines of a region in the image condition area 2104 which corresponds to condition number 1 in the search condition list 607 are blinked in the search instruction area 2102, and the character string of a keyword in the keyword area 2106 is blinked. In this case, “condition number” is a number for identifying each condition information. Serious numbers are set in this field with 1 being assigned to the condition number of the first condition information in the search condition list 607. The search condition list 607 will be described later.

When the switching button 2110 is repeatedly clicked, similar processing is repeated in the order of condition number 2, condition number 3, in the search condition list 607, thereby switching regions and keywords corresponding to blinking conditions. When the processing for all search results in the search condition list 607 is complete, the state before the first clicking of the switching button 2110, i.e., the state immediately after the completion of the processing in step S408, is restored. Note that target thick lines to be blinked can be easily obtained by using “region coordinates” in the search result list 609 and search condition list 607.

When the switching button 2110 is not to be clicked, a keyword displayed in the keyword area 2106 or a region displayed in the image condition area 2104 is clicked with the mouse 209. With this operation, a target keyword character string is obtained from the coordinates pointed by the clicked mouse cursor or a target region is obtained by searching the search condition list 607, and a corresponding condition number is obtained, thereby blinking the thick lines of the region in the image condition area 2104 which corresponds to the condition number and the character string of the keyword in the keyword area 2106. In addition, thick lines corresponding to a region in the region comparison buffer 608 which corresponds to the condition number in the thumbnail displayed in the search result display area 2103 are blinked.

In step S410, a branch occurs to the execution of the end of the processing in accordance with an instruction from the operator. That is, when an end button 2112 is clicked with the mouse 209 (Yes), it is determined that an instruction to end the image search processing is issued, and the image search processing is terminated. If a clear button 2111 is clicked (No), it is determined that an image search is to be performed again. In this case, the display in the image condition area 2104 and the display in the keyword area 2106 are cleared, and the search condition list 607 is initialized. The flow then advances to step S401.

The search condition designation processing in step S401 will be described with reference to FIGS. 11 and 18. By this search condition designation processing, search conditions for searching for an image are stored in the search condition list 607.

FIG. 11 is a view showing an example of the data arrangement of the search condition list 607 in this embodiment. Referring to FIG. 11, each row indicates the respective conditions for searching for a desired image. Information on each row which is associated with each condition will be referred to as “condition information” hereinafter. Each condition information in this embodiment is constituted by “condition number”, “region coordinates”, “keyword”, “color feature amount”, and “parent region”, as shown in FIG. 11.

First of all, “condition number” is a number for identifying each condition information. In this field, serial numbers are set with 1 being assigned to the condition number of the first condition information in the search condition list 607. When a partial image as a search condition, i.e., a region, is input in the image condition area 2104, “region coordinates” express the region by the vertexes of a polygon. A list of the coordinates of the vertexes is stored in this field. This expression method is the same as that for region coordinates in the region database 606. If no image as a search condition is designated as in condition information corresponding to condition number 1 in FIG. 11, no information is stored in “region coordinates”.

When words such as keywords which express contents as search conditions are input in the keyword area 2106, the character strings of these words are stored in “keyword”. These character strings need not be formed by one word, and may be expressed by a natural sentence. A plurality of contents can be stored in “keyword”. In this case, the contents can be separated by delimiting the character strings expressing the contents with “,”. If no keyword as a search condition is designated as in condition information corresponding to condition number 3 in FIG. 11, no information is stored in “keyword”.

When a partial image as a search condition, i.e., a region, is input in the image condition area 2104, the color feature amount of the region is stored in “color feature amount”. The expression method for this is the same as that for the color feature amounts in the region database 606. If no image as a search condition is designated as in condition information corresponding to condition number 1 in FIG. 11, no information is stored in “color feature amount”.

In addition, the value which is valid when region information in a thumbnail displayed in the search result display area 2103 is copied to the image condition area 2104 is stored in “parent region”. As will be described later, if a region to be copied has child regions in the region database 606, the pieces of information of these regions are also copied by tracing back the descendant regions. In such a case, “condition number” of parent search information is stored in “parent region” of search information having a parent region. The invalid value “−1” is stored in “parent region” of condition information having no parent region.

FIG. 18 is a flow chart for explaining in detail a sequence for search condition designation processing in step S401 in the processing by the image search program in FIG. 17. First of all, a branch occurs to the subsequent processing in accordance with operation by the operator (step S501). If the handwriting button 2105 in FIG. 21 is clicked with the mouse 209, the flow advances to step S502. If a thumbnail image displayed in the search result display area 2103 is clicked with the mouse 209, the flow advances to step S503. If the image condition area 2104 is clicked with the mouse 209, the flow advances to step S506. If the keyword area 2106 is clicked with the mouse 209, the flow advances to step S508. If the search button 2107 is clicked with the mouse 209, the search condition designation processing is terminated.

Step S502 is the processing to be performed when the handwriting button 2105 is clicked with the mouse 209. A partial image such as a graphic pattern as a search condition is input to the image condition area 2104 by handwriting inputting with the mouse 209. Then, “region coordinates” are extracted from the input partial image, i.e., the input region. In addition, “color feature amount” of this region is extracted. A technique about inputting of a graphic pattern with the mouse is processing which is generally performed and known, e.g., a drawing application in Microsoft Word 2000, and hence a detailed description thereof will be omitted.

In this case, with regard to “region coordinates” of the input region, by obtaining a polygon circumscribed to the input region, the vertexes of the polygon can be obtained. In addition, “feature amount” of the region is obtained by the same method as the method described above. “Region coordinates” and “color feature amount” obtained in this manner are added immediately after the valid condition information stored in the search condition list 607. With this operation, “condition number” is also automatically calculated. As a result, “keyword” is cleared, and “−1” is stored in “parent region”. When the processing is complete, the flow advances to step S501. In the state after step S502, for example, condition information like that corresponding to condition number 3 in FIG. 11 is set.

Step S503 is the processing to be performed when a thumbnail displayed in the search result display area 2103 is clicked with the mouse 209. When a thumbnail is clicked, the region where the clicked thumbnail is emphasized by being displayed is edged with thick lines. If a region in a thumbnail displayed in the search result display area 2103 is edged with thick lines, the thick lines are removed.

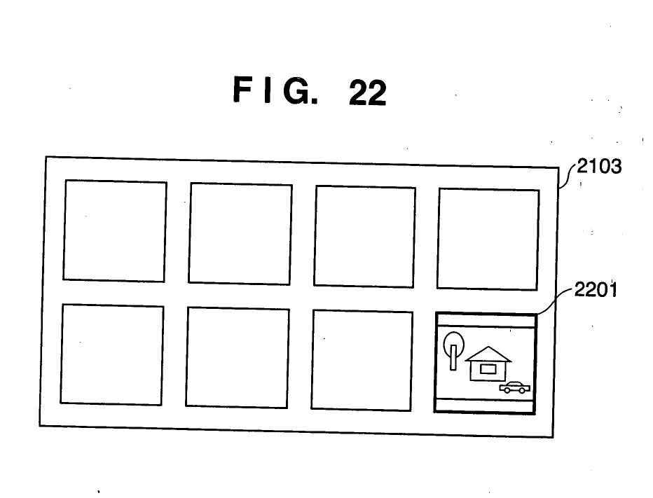

If, for example, the thumbnail 2109 in FIG. 21 is clicked, a thumbnail denoted by reference numeral 2201 in the search result display area 2103 shown in FIG. 22 is displayed. FIG. 22 is a view showing a window display example to explain a state wherein an image in the search result display area is selected to perform region selection processing by the image search program. When the processing is complete, the flow advances to step S504.

Step S504 is region selection processing of selecting a region from the thumbnail image emphasized in step S503. The details of this processing have been described with reference to FIG. 16. In the processing, a region is selected, and the selected region is dragged by using the mouse 209 and dropped at a predetermined position in the image condition area 2104. With this operation, the flow advances to step S505.

In step S505, the region selected in step S504 and its descendant regions are displayed at the position in the image condition area 2104 at which the regions are dropped. Step S505 is the processing of adding search conditions to the search condition list 607 on the basis of pieces of information about the region selected in step S504 and all descendant regions of the selected region.

If the region ID of the region selected in step S504 does not exist in the search result list 609, the region ID of a parent region existing in the search result list 609 is obtained by tracing back “parent region” in the image database 605. The reduction ratio between a polygonal region in the search result list 609 and a polygonal region in the region database 606 can be obtained from the relationship between the coordinates of a polygon which are stored in “region coordinates” in the search result list 609 and correspond to this region ID or the region ID of the region selected in step S504 and the coordinates of a polygon in “region coordinates” in the region database 606.

The coordinates of the polygons of the region selected in step S504 and its descendant regions are converted into reduced coordinates. In addition, the movement amount of the region can be obtained from the relationship between the coordinates of the polygon at the position in the image condition area 2104 at which the region selected in step S504 is dropped and the coordinates of the reduced polygon obtained in the above manner. The reduced coordinates of the polygons of the region selected in step S504 and its descendant regions are shifted to coordinates in the image condition area 2104. The reduced region coordinates obtained in this manner are sequentially added as individual conditions to “region coordinates” in the search condition list 607, starting from the region selected in step S504.

“Keyword” and “color feature amount” in the search condition list 607 are copied as “keyword” and “color feature amount” corresponding to each region in the region database 606. With respect to the region selected in step S504, “−1” is stored in “parent region” in the search condition list 607. With respect to the remaining regions, values are so stored as to maintain the same parent/child relationship by referring to “parent region” in the region database 606 and using “condition number” in the search condition list 607.

Assume that in the state shown in FIG. 23C, a wall 2305 is dragged and dropped into the image condition area 2104. In this case, as indicated by condition numbers 4 and 5 in the search condition list 607 in FIG. 11, the information of the wall region is registered as a condition together with the wall region. If the entire image is selected in step S504, the information of all the regions included in the selected image is added to the search condition list 607 in step S505.

After the search information is added to the search condition list 607, the region selected in step S504 is displayed at the position in the image condition area 2104 at which the region is dropped. In addition, the character strings of the currently added search conditions which are stored in “keyword” are displayed. In this case, the respective search conditions are displayed with line feeds. When the processing is complete, the flow advances to step S501.

Step S506 is the processing to be performed when the image condition area 2104 is clicked with the mouse 209. That is, in this processing, a region displayed in the image condition area 2104 is selected with the mouse 209. In this case, a region is selected in the same manner as in step S208 by referring to “condition number”, “region coordinates”, and “parent region” in the search condition list 607. In this case, a parent/child relationship is grasped by using condition numbers instead of region IDs. In the image condition area 2104, a selected region is displayed with its contour being edged with thick lines as in step S208. If there is a keyword corresponding to the selected region in the search condition list 607, the keyword displayed in the keyword area 2106 is displayed in a color different from those of the remaining keywords. When the processing is complete, the flow advances to step S507.

Step S507 is the processing of changing the size, position, and color of the region selected in step S506, as needed. Changing the size, position, and color of a graphic pattern (region) with the mouse is processing generally performed in a drawing application in Microsoft Word 2000 or the like and is known. A detailed description of this processing will therefore be omitted. In accordance with such changes, the values of “region coordinates” and “color feature amount” in the search condition list 607 are changed. If the selected region has child regions, similar changes are made by tracing back the descendant regions. When the processing is complete, the flow advances to step S501.

Step S508 is the processing to be performed when the keyword area 2106 is clicked. In this step, a keyword is input or edited. Assume no information is input to the image condition area 2104, no region is selected in the image condition area 2104, or the entire image condition area 2104 is selected. In this case, a keyword can be input regardless of the regions in the image condition area 2104. If the character strings displayed in the keyword area 2106 are present, the character strings are displayed in black. In addition, a new line is started at the line of the last character string displayed in the keyword area 2106, and the cursor is displayed at the start of the new last line.

When a keyword is input from the keyboard 207, the input character string is displayed in red. If a place other than keyword area 2106 is clicked with the mouse 209, the keyword input operation is terminated, and the keyword newly input in red is stored in the search condition list 607. For example, as indicated by condition number 1 in FIG. 11, “region coordinates” and “color feature amount” are cleared, and “−1” is stored in “parent region”. If a region in the image condition area 2104 has been selected and a character string has been stored in “keyword” in the search condition list 607 which corresponds to the region, the corresponding character string in the keyword area 2106 is displayed in red, and the remaining character strings are displayed in black, thereby allowing the operator to identify them. The cursor is displayed at the start of these character strings to allow the operator to edit the character strings and input a new keyword. A newly input character string is displayed in, for example, red.

If a region has been selected in the image condition area 2104 and no character string corresponding to the region is stored in “keyword”, the character strings displayed in the keyword area 2106 are displayed in black. In addition, a new line is started at the line of the last character string displayed in the keyword area 2106, and the cursor is displayed at the start of the new last line. This allows the operator to input a new keyword. Note that a newly input character string is displayed in, for example, red.

When a place other than the keyword area 2106 is clicked with the mouse 209, keyword inputting/editing operation is terminated, and the keyword input/edited in red is stored in “keyword” of the condition information in the search condition list 607 which corresponds to the selected region in the image condition area 2104. When the processing is complete, the flow advances to step S501. If there are a plurality of keyword contents, character strings expressing the contents are delimited with “,” and input. In the above embodiment, red and black are used as an example. However, the present invention may be applied to other combinations of colors. Character strings may be discriminated by using, for example, normal characters and underlined characters or shaded character as well as different colors.

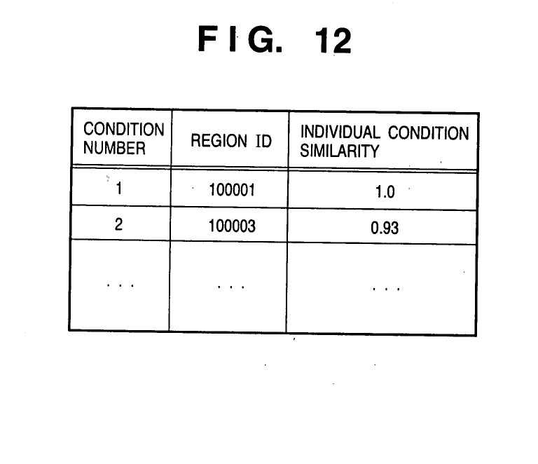

Similarity calculation processing in step S404 will be described next with reference to FIGS. 12 and 19.

FIG. 12 is a view showing an example of the data arrangement of the region comparison buffer 608 in which the result obtained by comparison with the search condition designated in step S401 with respect to the region in the image which is extracted in step S402. As shown in FIG. 12, the region ID of a region exhibiting the highest similarity with respect to each condition information in the search condition list 607 is stored in “region ID”. This similarity is stored in “individual condition similarity”, and the condition number of the condition information is stored in “condition number”.

FIG. 19 is a flow chart for explaining similarity calculation processing in step S404. First of all, the value of “similarity” in which the similarity between the search condition list 607 and the image extracted in step S402 is stored is initialized by storing “0” in “similarity” (step S601). The contents of the region comparison buffer 608 are also cleared.

The value of “individual similarity” in which the similarity between condition information in the search condition list 607 and the region in the image extracted in step S402 is stored is initialized by storing “0” in “individual similarity”. Pieces of condition information are extracted one by one from the start of the search condition list 607 (step S602). A branch then occurs to the subsequent processing depending on whether any condition information is extracted (step S603). If any condition information can be extracted (Yes), the flow advances to step S604. If all the pieces of condition information are extracted from the search condition list 607 (No), the flow advances to step S609.

In step S604, pieces of region information about the image extracted in step S402 are extracted from the region database 606 one by one. If any region information can be extracted in step S605 (No), the flow advances to step S606. If all the pieces of region information about the image extracted in step S402 are extracted (Yes), the flow advances to step S607.

In step S606, a similarity Sim between the condition information extracted in step S602 and the region information extracted in the image search program 604 is calculated, and the value of “individual similarity” is replaced with the calculated value of the similarity Sim if the calculated value of the similarity Sim is larger than the value stored in “individual similarity”. Note that when the value of “individual similarity” is to be updated, the region ID of the region information extracted in step S604 is stored as “region candidate”.

In this case, the similarity Sim is calculated by one of the following three calculation methods depending on the type stored in the condition information extracted in step S602.

(1) If all the pieces of information are stored,

Sim=((w1×S1)+(w2×S2)+(w3×S3)+(w4×S4))/(w1+w2+w3+w4)

(2) If the information of “keyword” is not stored,

Sim=((w2×S2)+(w3×S3)+(w4×S4))/(w2+w3+w4)

(3) If the information of “region coordinates” is not stored,

Sim=S1

where S1, S2, S3, and S4 are a keyword similarity, color feature amount similarity, size similarity, and position similarity, respectively, and w1, w2, w3, and w4 are weights for the respective types of similarities.

The keyword similarity S1 is calculated from “keyword” in the condition information extracted in step S602 and “keyword” in the region information extracted in step S604. Since a plurality of character strings are stored while being delimited with “,”, all combinations thereof will be compared. If there are character strings which perfectly match with each other, the value of S1 is set to “1.0”. Since character strings may be formed from natural sentences, any character strings which perfectly match each other may not be found. In this case, morphemic analysis of character strings is performed to divide the character strings into words to extract only nouns, adjectives, and verbs as words. Character strings constituted by theses words are then compared with each other. The value obtained by dividing the number of words that match with each other upon comparison by the number of words used for the comparison is set as the value of S1.

The color feature amount similarity S2 is calculated from “color feature amount” in the condition information extracted in step S602 and “color feature amount” in the region information extracted in step S604. Since the total histogram frequency is normalized with 1,000, the color feature amount similarity S2 can be obtained from the sum of the absolute values of the differences between the respective elements of “color feature amount”.

S2=1−(Σ|h1i−h2i|)/2000

where h1i is the ith element of “color feature amount” in the condition information extracted in step S602, and h2i is the ith element in “color feature amount” in the region information extracted in step S604.

The size similarity S3 is calculated from “region coordinates” in the condition information extracted in step S602 and “region coordinates” in the region information extracted in step S604. A method of calculating a size similarity from the area of a polygon as a region can be listed as a known technique. For the sake of simplicity, a method of calculating a size similarity from the area of a rectangle circumscribed to a region is used.

A circumscribed rectangle can be simply obtained by obtaining the minimum and maximum x- and y-coordinates from “region coordinates” in the respective steps. “Region coordinates” in the condition information extracted in step S602 are the coordinates in the image condition area 2104, and differ in scale from the image stored in the image database 605. If the numbers of pixels of the image condition area 2104 in the vertical and horizontal directions are both 120, the area of the region information is adjusted in scale in the following manner:

(area of region information)←(area of region information)×((120×120)/((vertical size of image)×(horizontal size of image)))

The vertical and horizontal sizes of the image can be obtained from the image database 605.

Subsequently, the size similarity S3 can be calculated as follows:

(1) If the area of the region information is larger than that of the condition information,

S3=1−((area of condition information)/(area of region information))

(2) If the area of the region information is smaller than the area of the condition information,

S3 =1−((area of region information)/(area of condition information))

In addition, the position similarity S4 is calculated from “region coordinates” in the condition information extracted in step S602 and “region coordinates” in the region information extracted in step S604. A method of calculating a position similarity from the center of gravity of a polygon as a region can be listed as a known technique. In this case as well, for the sake of simplicity, a method of calculating a position similarity from the center of gravity of a rectangle circumscribed to a region is used.

A circumscribed rectangle can be simply obtained in the above manner. As in the case wherein a size similarity is obtained, the coordinates of the gravity of center of region information are corrected to be adjusted in scale in the following manner.

(x-coordinate of region information)←(x-coordinate of region information)×(120/(horizontal size of image))

(y-coordinate of region information)←(y-coordinate of region information)×(120/(vertical size of image))

The position similarity S4 can be calculated afterward as follows:

S4=1−((distance between condition information and center of gravity of region information)/(120×√2))

When the processing in step S606 is complete, the flow advances to step S604.

Step S607 is the processing of registering the result obtained by comparison in steps S604 to S606 in the region comparison buffer 608. If the value of “individual similarity” is not 0, the value of the condition number of the condition information extracted in step S602 is stored in “condition number”; the value of “region candidate”, in “region ID”; and the value of “individual similarity”, in “individual condition similarity”. If the value of “individual similarity” is 0, no information is registered in the region comparison buffer 608. When the processing is complete, the flow advances to step S608. In step S608, the value of “individual similarity” is added to “similarity”, and the flow advances to step S602.

Step S609 is the processing of normalizing the value stored in “similarity” with the number of pieces of condition information stored in the search condition list 607. In this case, the value stored in “similarity” is replaced with the value obtained by dividing the value stored in “similarity” by the number of pieces of condition information. When the processing is complete, the similarity calculation processing is terminated.

Thumbnail generation processing in step S406 will be described next with reference to FIG. 20. FIG. 20 is a flow chart for explaining in detail the thumbnail generation processing in step S406.

A rectangular region enclosing a region of the regions stored in the region comparison buffer 608 which has no parent region in the search condition list 607 is generated on the image extracted in step S402 (step S701). More specifically, the region IDs stored in the region comparison buffer 608 are extracted one by one, and the minimum x- and y-coordinates and maximum x- and y-coordinates of only a region whose value of “parent region” corresponding to the search condition list 607 is “−1” are obtained from the corresponding region coordinates in the region database 606 on the basis of the corresponding condition number. This makes it possible to obtain a rectangular region circumscribed to the region. In this case, since rectangular regions are synthesized to generate thumbnails, a rectangular region larger than the circumscribed region is generated. A target rectangular region can be generated by subtracting predetermined values from the minimum x- and y-coordinates and adding predetermined values to the maximum x- and y-coordinates. Obviously, these calculations make the coordinate values fall within the image.

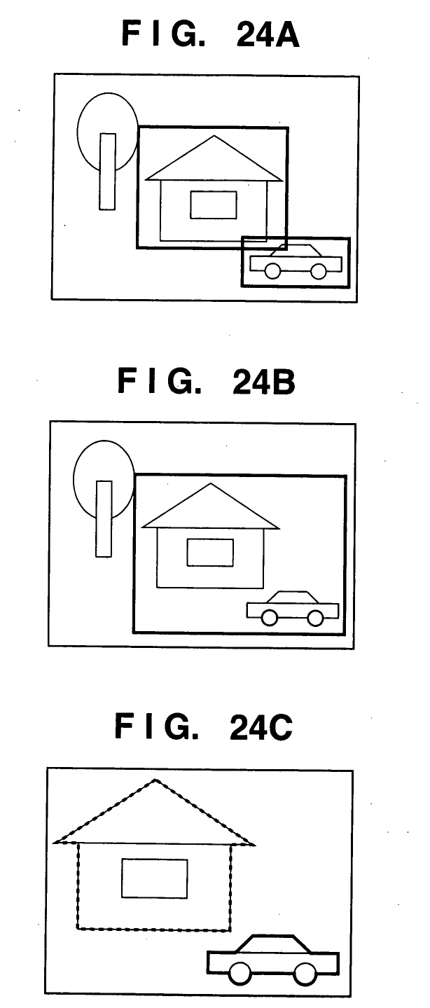

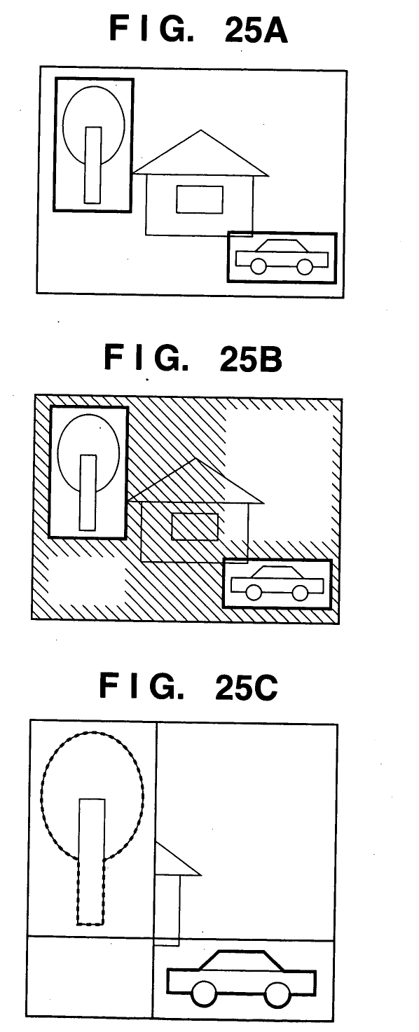

If, for example, regions with the region IDs “100001” and “100002” exist in the region comparison buffer 608 with respect to the image shown in FIG. 8, rectangular regions surrounding the car and house as shown in FIG. 24A can be obtained from the region database 606 shown in FIG. 10. FIGS. 24A to 24C are views for explaining how thumbnail generation processing according to an embodiment is performed. If regions with the region ID “100001” and “100003” exist in the region comparison buffer 608, rectangular regions surrounding the car and tree can be obtained, as shown in FIG. 25A. FIGS. 25A to 25C are views for explaining how thumbnail generation processing according to another embodiment is performed.

In step S702, rectangular regions which are obtained in step S701 and overlap each other are integrated. Whether two rectangular regions overlap each other can be easily determined by comparing the minimum x- and y-coordinates and maximum x- and y-coordinates of the two rectangular regions. If the two rectangular regions overlap each other, smaller values of the minimum x- and y-coordinates of the two regions are set as the minimum x- and y-coordinates of the new rectangular region. Likewise, larger values of the x- and y-coordinates of the two regions are set as the maximum x- and y-coordinates of the new rectangular region.

Regions are continuously integrated by repeatedly comparing two regions in this manner. When region integration cannot be done anymore, the flow advances to step S703. If, for example, the two rectangular regions shown in FIG. 24A exist, the rectangular region shown in FIG. 24B is generated as a result of integration.

In step S703, the position of each rectangular region on a thumbnail image which has been obtained in the processing up to step S702 is determined. According to the simplest method, the minimum rectangular region including all the rectangular regions obtained in the processing up to step S702 is obtained, and the obtained region is used as a thumbnail image. Such a rectangular region can be obtained by obtaining the minimum x- and y-coordinates from the respective rectangular regions, setting the obtained coordinates as the coordinates of the upper left point of the rectangular region, obtaining the maximum x- and y-coordinates, and setting the obtained coordinates as the coordinates of the lower right point of the rectangular region.

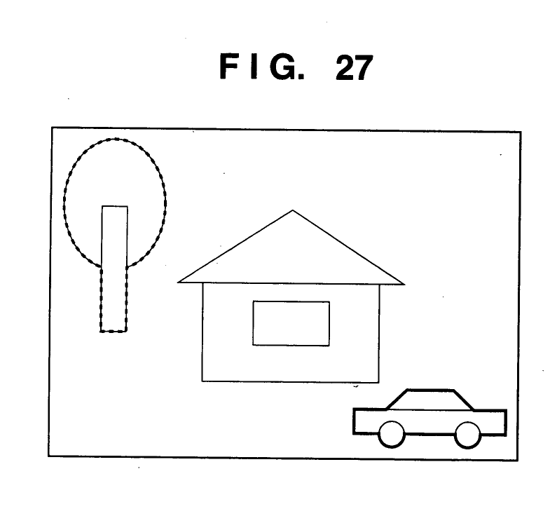

In this embodiment, since the maximum horizontal and vertical sizes of a thumbnail image are both set to 120 pixels, it suffices if the rectangular region is reduced or enlarged such that the size of a longer one of the vertical and horizontal sizes of the rectangular region is set to 120 pixels. With this operation, on the thumbnail image, both the x- and y-coordinates of the upper left point of the rectangular region including all the rectangular regions become 0, and one or both of the x- and y-coordinates of the lower right point become 120. With this processing, if, for example, the rectangular region shown in FIG. 24B is obtained in step S702, the arrangement of the rectangular region on the thumbnail image becomes the one shown in FIG. 24C. If the rectangular regions shown in FIG. 25A are obtained, the arrangement of the rectangular regions on the thumbnail image become those shown in FIG. 27. When the processing is complete, the flow advances to step S704. FIG. 27 is a view for explaining the thumbnail image generation result obtained by thumbnail generation processing.

In step S704, coordinates indicating a region on a thumbnail image which is stored in the region comparison buffer 608 are obtained by converting the region coordinates stored in the region database 606. Assume that the minimum rectangular region which is obtained in step S703 and includes all the rectangular regions is long from side to side. In this case, letting x0 be the x-coordinate value of the upper left point of this rectangular region, y0 be the y-coordinate value of the region, x1 be the horizontal size of the region, x be the x-coordinate of the region coordinates stored in the region database 606, and y be the y-coordinate of the region coordinates, an x-coordinate x′ and y-coordinate y′ of the region coordinates on the thumbnail after conversion can be obtained by

x′=(120/x1)x−x0

y′=(120/x1)y−y0

If the rectangular region is longer than wide, the region coordinates can be converted in the same manner as described above. The region coordinates obtained in this case are stored in “region coordinates” in the search result list 609. When the processing is complete, the flow advances to step S705.

Step S705 is the processing of synthesizing a thumbnail image. According to the above rectangular region arranging method, the minimum rectangular region enclosing all rectangular regions itself becomes a thumbnail image. In addition, each region on the thumbnail image is edged with thick lines in a color determined in advance by a search number with respect to the regions stored in the region comparison buffer 608 on the basis of “region coordinates” of each region on the thumbnail image obtained in step S704.

Referring to FIG. 24C, for example, the car is edged with the solid lines, whereas the house is edged with the broken lines. This indicates that these lines differ in color. Obviously, regions can be edged with different kinds of lines such as solid lines, dotted lines, and double lines instead of being displayed in different colors for the respective condition numbers. If regions are displayed in different forms so as to discriminate the regions for the respective condition numbers, the same effect as that described above can be obtained. When the processing is complete, the thumbnail generation processing is terminated.

According to the above thumbnail generation method, as shown in, for example, FIG. 27, when the regions stored in the region comparison buffer 608 exist at two ends, the regions satisfying search conditions may also be displayed small on the thumbnail image displayed as a search result. Another thumbnail generation method for making an improvement for such a case will be described below.

Basically, this method is executed by the same sequence as that shown in the flow chart of FIG. 20. However, when the arrangement of the rectangular regions generated in step S701 is determined in step S703, the rectangular regions are arranged after regions corresponding to the x-coordinate and y-coordinate values which are not used by the rectangular regions are removed. The x-coordinate and y-coordinate values which are not used by the rectangular regions can be easily obtained by projecting all the rectangular regions on the x- and y-axes and considering the inclusive relationship between the regions on the x- and y-axes.

If, for example, the rectangular regions shown in FIG. 25A are generated in step S701, the regions displayed in dots in FIG. 25B are regions corresponding to the x-coordinate and y-coordinate values which are not used by the rectangular regions. If the rectangular regions are arranged upon removal of such regions, they are arranged as shown in FIG. 25C. In the region coordinate conversion processing in step S704, since the coordinates of the upper left point of each rectangular region on the thumbnail image can be known, the region coordinates can be easily converted in the same manner as described above.

In the thumbnail image synthesis processing in step S705, the rectangular regions are arranged on the thumbnail image on the basis of the arrangement of the respective rectangular regions determined in step S703, and the regions which have not been removed in step S703 are arranged on the thumbnail image in the same manner, thereby synthesizing a thumbnail image. For example, the image shown in FIG. 24A becomes the one shown in FIG. 24C as a thumbnail image.

According to the above thumbnail generation method, if the regions stored in the region comparison buffer 608 greatly differ in size, a smaller region is not displayed large. This may make it difficult to visually check the region. Still another thumbnail generation method for making an improvement for such a case will be described below.

Basically, this method is executed by the same sequence as that shown in the flow chart of FIG. 20. If a plurality of rectangular regions are present after the formation of a rectangular region surrounding the regions stored in the region comparison buffer 608 in step S701, integration of the rectangular regions in step S702 is not performed. Instead of this operation, the rectangular regions are enlarged or reduced such that the respective rectangular regions have the same area.

For example, the area of the largest rectangular region is obtained, and the areas of other rectangular regions are increased to become equal to the area of the largest rectangular region. In this case, the values of “region coordinates” stored in the region database 606 in correspondence with the coordinates of the vertexes of polygonal regions included in the respective rectangular regions are converted in advance into coordinates with the upper left point of each rectangular region being set as an origin. This processing can be implemented by using the same method as that described in association with step S704. Obviously, it also suffices to make target regions themselves have the same area instead of making rectangular regions have the same area.

Subsequently, as in step S703, the arrangement of the rectangular regions on the thumbnail image is determined. Rectangular regions made to have the same area are sequentially extracted starting from one of the rectangular regions generated in step S701 whose x-coordinate and y-coordinate values of the coordinates of the upper left point are smallest, and the rectangular regions are sequentially arranged from the upper left point of an image to be synthesized such that the synthetic image to be finally generated has an area as small as possible.

For example, after the first rectangular region is placed, the second and subsequent rectangular regions are arranged in the following manner. The upper left point of a polygon synthesized by already arranged rectangular regions is set as an origin, and a search is made from a vertex, other than the origin, having 0 as an x-coordinate value to a vertex having 0 as a y-coordinate value. The upper left point, upper right point, and lower left point of the rectangular region to be placed are matched with vertexes under search, thereby obtaining the placement position of the rectangular region at which the coordinate value of the vertex of the rectangle to be placed is equal to or larger than 0, the rectangular region does not overlap the polygon synthesized by already arranged rectangular regions, and the area of a rectangle circumscribed to a polygon to be synthesized after placement is minimized.

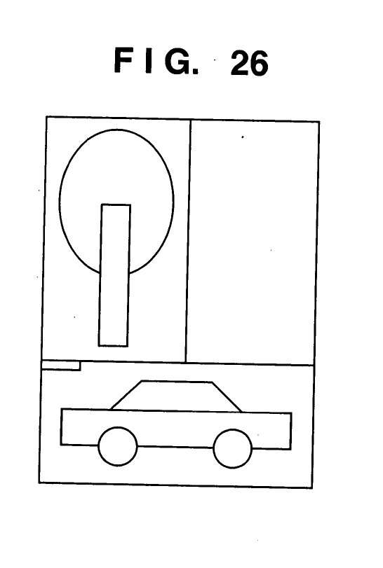

For example, the rectangular regions of the tree and car shown in FIG. 25A are so arranged as to have the same area, as shown in FIG. 26. FIG. 26 is a view for explaining how thumbnail image generation processing is performed when the areas of a plurality of rectangular regions are made uniform. A rectangle circumscribed to the rectangular regions arranged in this manner is a basis of a thumbnail image. The image is reduced or enlarged to make a long side of the circumscribed rectangle have a length of 120 pixels, thereby generating a thumbnail image.

In step S704, coordinates representing a region stored in the region comparison buffer 608 are obtained on the basis of the region coordinates of a region in the rectangle obtained in step S701. The coordinates of the upper left vertex of a rectangular region surrounding the respective regions on a thumbnail image can be easily obtained in this manner, and hence can be easily obtained by the same method as that described in association with step S704. Thereafter, a thumbnail image is synthesized by the same method as that described in association with step S705.

The above thumbnail generation method displays only the regions stored in the region comparison buffer 608 without displaying the entire image, and hence the operator may not grasp the entire image. If, for example, a thumbnail like the one shown in FIG. 24C is generated, the tree is not displayed, as seen from FIG. 24A. If the thumbnail shown in FIG. 26 is generated, the house is not displayed. Still another thumbnail generation method for making an improvement for such a case will be described below.

In this case, a plurality of thumbnail images are generated unlike in the prior art wherein only one thumbnail is generated. One thumbnail image is an image obtained by reducing an image in the image database 605. This image is reduced such that the size of a longer side, either the vertical size or the horizontal size, becomes 120 pixels. As in step S704, the contour of each region on a thumbnail image, which is stored in the region comparison buffer 608, is edged with thick lines in a color determined by the search number. As other thumbnail images, thumbnail images are generated one by one with respect to regions of the regions stored in the region comparison buffer 608 which have no parent region in the search condition list 607. The method of generating these thumbnail images basically takes the same sequence as that in the flow chart of FIG. 20, but there is no need to perform the rectangular region integration in step S702.

In the rectangular region arrangement determination processing in step S703, the aspect ratio of a thumbnail image to be generated is made equal to that of an image in the image database 605. The two vertical or horizontal sides of this thumbnail image are aligned with the corresponding two sides of the rectangular region generated in step S701. When, however, an image in the image database 605 is extracted in the form of a rectangle as a thumbnail image based on this positional relationship, and the outside of the image in the image database 605 is extracted, the position of the rectangle as the thumbnail image and the position of the rectangular region generated in step S701 are shifted and corrected such that the extracted image is located inside.

In step S704, the coordinates of the rectangular region can be converted in the same manner as described above. In step S705, on the image in the image database 605, a thumbnail image is extracted from the image in the image database 605 on the basis of the positional relationship between the rectangular region generated in step S701 and the rectangle of the thumbnail image determined in step S703, and the extracted image is reduced such that the size of a longer one of the vertical and horizontal sizes becomes 120 pixels. As described above, then, the contour of the region on the thumbnail image is edged with thick lines in a color determined by the search number.

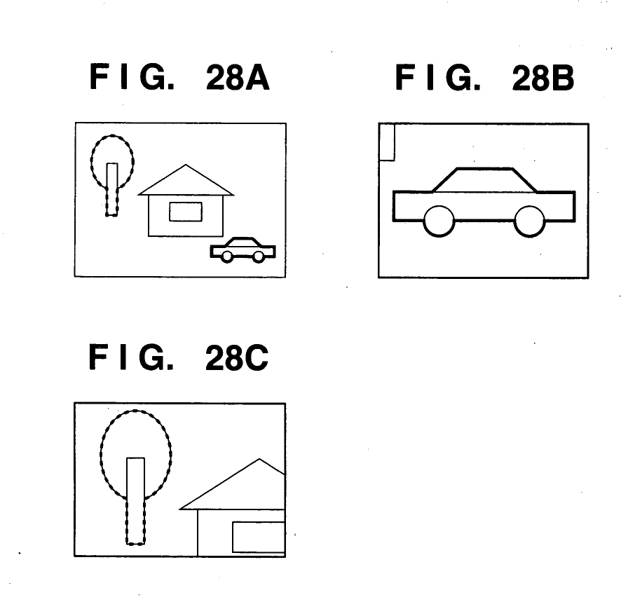

If, for example, regions with the region IDs “100001” and “100003” are present in the region comparison buffer 608 with respect to the image shown in FIG. 8, the thumbnail image obtained by reducing the image in the image database 605 becomes the one shown in FIG. 28A. FIGS. 28A to 28C are views for explaining an embodiment of thumbnail generation processing of generating a plurality of thumbnails with respect to one image. In addition, a thumbnail image corresponding to the region ID “100001” becomes the one shown in FIG. 28B, and a thumbnail image corresponding to the region ID “100003” become the one shown in FIG. 28C.

When a plurality of thumbnail images are to be generated with respect to one image in this manner, “thumbnail image” in the search result list 609 is extended to generate a plurality of thumbnail images. For example, each file name is quoted with “ ””, and the file names quoted with “ ”” are delimited with “,”, 1 thereby allowing a plurality of thumbnail images to be stored. The file names are sequentially stored in “thumbnail image”, starting from the thumbnail image obtained by reducing the image in the image database 605, followed by a thumbnail image corresponding to the first region ID in the region comparison buffer 608.

In step S408, when thumbnail images are to be displayed in the search result display area 2103, a plurality of thumbnail images may be automatically and sequentially displayed in an alternate manner like a slide show. When the switching button 2110 is repeatedly clicked with the mouse 209 in step S409, images are displayed in the search result display area 2103 by the same display method as that described in association with step S409. In this case, each thumbnail is displayed in the search result display area 2103 while the mode of automatically and alternately displaying thumbnails is inhibited. At first, the thumbnail image obtained by reducing the image in the image database 605 is displayed. Every time the switching button 2110 is clicked, a thumbnail including the region indicated by the region ID in the region comparison buffer 608 which corresponds to a target condition number is displayed, and the thick lines of the region are blinked. When thumbnail images corresponding to all the condition numbers are alternately displayed, the state wherein thumbnail images are automatically and sequentially displayed in an alternate manner is restored.

When a plurality of thumbnail image are generated with respect to one image in this manner, these thumbnail images may be simultaneously displayed side by side in the search result display area 2103. In this case, the adjacent thumbnail images need to be surrounded with thick lines to allow the operator to know that they are thumbnails with respect to the same image.

Note that this embodiment has exemplified the case wherein the image registration program and image search program are directly loaded from the CD-ROM as an external storage device into the RAM 203 to be executed. Alternatively, the image registration program and image search program may be temporarily stored (installed) from the CD-ROM into the hard disk drive 206, and may be loaded from the hard disk drive 206 into the RAM 203 when they are executed.

As a medium for recording the image registration program and image search program, an FD (Flexible Disk), IC memory card, or the like may be used instead of the CD-ROM.

In addition, the image registration program and image search program may be recorded on the ROM 202 as part of the memory map so as to allow the CPU 201 to directly execute them.

Furthermore, the image registration program and image search program may be stored in a server on a network, and may be downloaded from the server on the network into the RAM 203 through the network card 210 as needed.

This embodiment has exemplified the embodiment of making a search for a still image stored in the image database 605. In addition to the image database 605, however, a moving image database may be prepared. Still images of a plurality of key frames are then made to correspond to each moving image data and stored in the image database 605. The above method is used to search for a key frame stored in the image database 605 to search for a corresponding moving image. In this case, in addition to a key frame, a position from the start of the moving image corresponding to the key frame on the time axis may be stored to allow playback of the moving image from the position on the time axis after the key frame is searched out.

In this embodiment, similarities with search conditions are calculated by using colors and the sizes and positions of regions as image features of the regions. However, since the region coordinates stored in the region database 606 themselves represent the shapes of the regions, the shape of each region may be used to calculate a similarity with a search condition.

In this embodiment, the contour of a region is expressed by a polygon, and the coordinates of the vertexes of the polygon are stored in “region coordinates” in the region database 606. However, a region may be expressed in the form of a rectangle circumscribed to the region, and only the coordinates of the upper left and lower right points of the rectangle circumscribed to the region may be stored. This makes it possible to reduce the storage capacity for region coordinates in the region database 606.

In this embodiment, “keyword” is stored in the region information in the region database 606 to express the contents of a region. However, a concept code corresponding to the contents of a region may be stored instead of a keyword. In this case, a concept code is, for example, a unique number assigned to each node in a thesaurus that expresses a concept system in the form of a tree structure.

More specifically, in the keyword setting processing in step S203, a list of nodes (concepts) in the thesaurus is displayed to allow selection of a desired concept. The selected concept is then stored in the region database 606. Alternatively, the thesaurus may be searched by using a keyword input in the keyword setting processing in step S203 as a key to obtain a concept code corresponding to the keyword, and the obtained code may be stored in the region database 606. Concept codes are stored instead of keywords of condition information in the search condition list 607. A keyword input or edited in step S508 can be replaced with a concept code in the same manner as described above and stored in the search condition list 607. When the similarity Sim is calculated in step S606, a concept code similarity is used instead of a keyword similarity. If concept codes coincide with each other, the concept code similarity is set to “1.0”.

In this embodiment, basically, as a thumbnail image corresponding to an image extracted in step S402, a partial image of the image or an image obtained by synthesizing regions is used instead of an image obtained by simply reducing the extracted image. If the ratio of the area of the region stored in the region comparison buffer 608 to the area of the image is equal to or higher than a predetermined ratio, an image obtained by simply reducing the image may be used as a thumbnail image.

In this embodiment, with regard to a target image, a thumbnail image is synthesized in step S705 by using a rectangular partial image circumscribed to a region, and hence the partial image outside the region is included in the thumbnail image. For this reason, a thumbnail image may be synthesized by using only an image within a region without using any partial image outside the region.

In this embodiment, a thumbnail image is generated in step S406. Assume, however, that complicated regions are not synthesized. In this case, only the coordinates of a rectangular region to be displayed in the search result display area 2103 may be stored with respect to a target image, and only a partial image of the target image may be displayed on the basis of the stored coordinates when a thumbnail image is displayed in the search result display area 2103 in step S408.

In this embodiment, a thumbnail image is generated in step S406. However, thumbnail images may be generated in advance with respect to all combinations of registered regions before the image registration program is terminated after step S211, and a thumbnail image corresponding to the region stored in the region comparison buffer 608 may be obtained by a search instead of step S406.

This embodiment has exemplified the case wherein only one region exhibiting the highest similarity with each condition information in the search condition list 607 can be registered in the region comparison buffer 608. However, the embodiment may allow a plurality of regions equal to or higher than a specific threshold may be registered with respect to one condition information. In order to allow this operation, a plurality of “individual similarity” and “region candidate” fields, which are used in the similarity calculation processing in step S404, are prepared in the form of an array. If the value of the similarity Sim calculated in step S606 is larger than a specific threshold, the value of Sim and the region ID are stored in the array of “individual similarity” and “region candidate” fields. In step S607, the information stored in the array of “individual similarity” and “region candidate” fields is registered in the region comparison buffer 608.

As described above, the image search apparatus according to the present invention includes the image storage unit 101 which stores a plurality of images, the region information storage unit 102 which stores specific partial images included in the respective images stored in the image storage unit 101 in correspondence with the respective images, and the region feature storage unit 103 which stores features of the partial image stored in the region information storage unit 102 in correspondence with the partial images. The image feature designation unit 104 designates a feature of a search target image. The candidate image decision unit 105 searches the features of the partial images stored in the region information storage unit 102 on the basis of the designated image feature, and determines an image as a candidate image among the image stored in the image storage unit 101 which is associated with the partial image obtained on the basis of the search result. The search result display unit 106 is characterized in that a partial image included in the determined candidate image is enlarged to a predetermined size, and a reduced image of the candidate image is displayed.

The image search apparatus according to the present invention is characterized in that when a plurality of candidate images are obtained on the basis of a search result, the search result display unit 106 displays a list of reduced images of the plurality of candidate images.

The image search apparatus according to the present invention is also characterized in that the search result display unit 106 displays reduced images within an area having a predetermined size.

In addition, the image search apparatus according to the present invention is characterized in that a partial image is a rectangular image having a region surrounded with a circumscribed rectangle of a predetermined object region included in an image.

Furthermore, the image search apparatus according to the present invention is characterized in that the search result display unit 106 displays a reduced image of a candidate image while emphasizing a partial image included in the candidate image.

Moreover, the image search apparatus according to the present invention is characterized in that a feature of an image is at least one of concept information expressing a concept obtained from a partial image, language information expressing the concept in a language, an image feature expressing a feature of a partial image, and a combination of concept information, language information, and an image feature.

As described above, according to this embodiment, since the search result display unit 106 displays a region whose feature is determined to be identical or similar to a designated feature or a partial image including the region while emphasizing it to make it easy to visually identify it among images obtained as a search result, a region (object or the like) that satisfies a search condition can be easily found.

If a plurality of such regions are present among images obtained as a search result, the search result display unit 106 alternately displays the regions to be emphasized or partial images including the regions while emphasizing them to make it easy to visually identify them among images obtained as a search result. This makes it possible to easily search for a region (object or the like) that satisfies a search condition.

In addition, the search result display unit 106 displays regions which are determined by the candidate image decision unit 105 to identical or similar to a feature selected by the image feature selection unit or partial images including the regions while switching targets to be emphasized. This makes it possible to easily search for a region (object or the like) corresponding to an individual search condition.

Furthermore, as described above, the search result display unit 106 makes it easy to search for a region satisfying a search condition in an image obtained as a search result with respect to one candidate image. Therefore, as shown in FIG. 21, when a plurality of candidate images are displayed in the form of a list, a region that satisfies a search condition can be easily found, in particular. This improves the search operation efficiency.

<Second Embodiment>

An outline of an image search apparatus according to the second embodiment of the present invention will be described first. The arrangement of the image search apparatus according to the second embodiment of the present invention is the same as that of the image search apparatus according to the first embodiment shown in the block diagram of FIG. 1. However, a search result display unit 106 displays a partial image of a candidate image which is determined by a candidate image decision unit 105 and includes a plurality of regions whose features are determined to be identical or similar to a designated feature. The search result display unit 106 also displays images of a plurality of regions or an image obtained by synthesizing partial images including these regions.

In addition, the search result display unit 106 displays an image which is synthesized such that the relative positional relationship between a plurality of regions is maintained. The search result display unit 106 also displays an image which is synthesized such that these regions have the same size. Furthermore, the search result display unit 106 displays an image of a region or an image including a region to make it easy to visually recognize the position of the image.

The operations of the search result display unit 106 and the remaining units in the image search apparatus having the above arrangement are the same as those described in the first embodiment. The image search apparatus according to the present invention includes an image storage unit 101 which stores a plurality of images, a region information storage unit 102 which stores predetermined partial images included in the respective images stored in the image storage unit 101 in correspondence with the respective images, and a region feature storage unit 103 which stores features of the partial images stored in the region information storage unit 102 in correspondence with the partial images. An image feature designation unit 104 designates a feature of an image as a search target. The candidate image decision unit 105 searches for features of partial images stored in the region feature storage unit 103 on the basis of the designated image feature, and determines an image made to correspond to the plurality of partial images obtained on the basis of the search result as a candidate image from the images stored in the image storage unit 101. The search result display unit 106 then enlarges a plurality of partial images included in the determined candidate image to a predetermined size and displays a reduced image of the candidate image.

The image search apparatus according to the present invention is characterized in that the search result display unit 106 synthesizes a plurality of partial images to generate a new partial image, and displays the new partial image as a reduced image.

The image search apparatus according to the present invention is characterized in that the search result display unit 106 synthesizes a plurality of partial images to generate a new partial image while keeping the relative positional relationship between the plurality of partial images.

The image search apparatus according to the present invention is also characterized in that when a plurality of partial images partly overlap each other, the search result display unit 106 synthesizes the plurality of partial images to generate a new partial image.

The image search apparatus according to the present invention is further characterized in that the sizes of a plurality of partial images are unified to a predetermined size.

As described above, according to the image search apparatus of this embodiment, the search result display unit 106 displays a partial image of a candidate image including a plurality of regions satisfying the search condition designated by the image feature designation unit 104 as a search result image. This makes it easy to find a region (object or the like) satisfying the search condition. In addition, the states of the details of the region can be easily grasped.

In addition, the search result display unit 106 displays images of a plurality of regions or an image obtained by synthesizing partial images including these regions as a search result image. This makes it easy to find a region (object or the like) satisfying the search condition. In addition, the states of the details of the region can be easily grasped.

Furthermore, since the search result display unit 106 displays an image which is so synthesized as to keep the relative positional relationship between a plurality of regions, the relationship between the regions can be easily grasped in the entire image.

Moreover, the search result display unit 106 displays an image as a search result image which is synthesized such that a plurality of region images or partial images including the region images have the same or almost the same size. Even if, therefore, the respective regions in the image greatly differ in size, a region (object or the like) which satisfies a search condition can be easily found. In addition, the states of the details of the region can be easily grasped.

<Third Embodiment>

An outline of an image search apparatus according to the third embodiment of the present invention will be described next. The arrangement of the image search apparatus according to the third embodiment of the present invention is the same as that of the image search apparatus according to the first embodiment shown in the block diagram of FIG. 1. However, a search result display unit 106 displays a plurality of reduced images as search result images with respect to one candidate image determined by a candidate image decision unit 105.

As described in the first embodiment, one thumbnail image is an image obtained by reducing an image in an image database 605 such that the size of a longer one of the vertical and horizontal sizes of the region becomes 120 pixels. As in step S704, with regard to the regions stored in a region comparison buffer 608, the contours of respective regions on a thumbnail image are edged with thick lines in colors determined by search numbers. As other thumbnail images, thumbnail images are generated one by one with respect to regions, of the regions stored in the region comparison buffer 608, which have no parent regions in a search condition list 607. A method of generating such thumbnail images basically takes the same sequence as that in the flow chart shown in FIG. 20. However, there is no need to perform rectangular region integration in step S702.

In addition, the search result display unit 106 includes, in a plurality of search result images with respect to one candidate image, partial images of the candidate image including regions whose features are determined by the candidate image decision unit 105 to be identical or similar to a designated feature. The search result display unit 106 also includes the candidate image in a plurality of search result images with respect to one candidate image. The search result display unit 106 also displays a plurality of search result images with respect to one candidate image in the same or almost same size.

Furthermore, the search result display unit 106 alternately displays a plurality of search result images with respect to one candidate image at the same position in accordance with an instruction from a switching unit (not shown). The search result display unit 106 alternately displays a plurality of search result images with respect to one candidate image in an automatic manner. In addition, the search result display unit 106 displays a region whose feature is determined by the candidate image decision unit 105 to be identical or similar to a designated feature or a partial image including the region so as to make it easy to visually identify it among search result images.

The operations of the search result display unit 106 and the remaining units in the image search apparatus having the above arrangement are the same as those described in the first embodiment. The image search apparatus according to the present invention includes an image storage unit 101 which stores a plurality of images, a region information storage unit 102 which stores predetermined partial images included in the respective images stored in the image storage unit 101 in correspondence with the respective images, and a region feature storage unit 103 which stores features of the partial images stored in the region information storage unit 102 in correspondence with the partial images. An image feature designation unit 104 designates a feature of an image as a search target. The candidate image decision unit 105 searches for features of partial images stored in the region feature storage unit 103 on the basis of the designated image feature, and determines an image made to correspond to the plurality of partial images obtained on the basis of the search result as a candidate image from the images stored in the image storage unit 101. The search result display unit 106 is characterized by displaying a reduced image of a determined candidate image in a plurality of patterns.

The image search apparatus according to the present invention is characterized in that the search result display unit 106 displays a list of a plurality of reduced images.

The image search apparatus according to the present invention is characterized in that the search result display unit 106 displays a reduced image of a candidate image.

The image search apparatus according to the present invention is characterized in that the search result display unit 106 displays a reduced image of a partial image used to determine a candidate image.

The image search apparatus according to the present invention is characterized in that the search result display unit 106 alternately displays reduced images one by one at the same position in an automatic manner.

The image search apparatus according to the present invention is characterized in that the apparatus further includes a switching unit for alternate display of reduced images, and the search result display unit 106 alternately displays the reduced images one by one at the same position.

As described above, according to the image search apparatus of this embodiment, the search result display unit 106 displays a plurality of images as search result images with respect to one candidate image, while the search result images includes images of regions satisfying the search condition designated by the image feature designation unit 104 or partial images including the regions. Therefore, a region (object or the like) that satisfies a search condition can be easily found. In addition, the states of the details of the region can be easily grasped.

In addition, since the search result display unit 106 includes the candidate image in a plurality of search result images with respect to one candidate image, the relationship between the regions in the entire image can be easily grasped.

Furthermore, since the search result display unit 106 displays a plurality of search result images with respect to one candidate image in the same or almost the same size, a region (object or the like) satisfying a search condition can be easily found. In addition, the states of the details of the region can be easily grasped.

Moreover, since the search result display unit 106 alternately displays a plurality of search result images with respect to one candidate image at the same position manually or automatically, a region (object or the like) that satisfies a search condition can be easily found. In addition, the states of the details of the region can be easily gasped, and the relationship between the regions in the entire image can be easily grasped.

<Other Embodiment>

In the above embodiments, the present invention is implemented in a stand-alone form. However, the present invention can be executed as services offered by a server on a network to allow a client machine to use the function of the present invention.

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

As has been described above, according to the present invention, when a search is made for an image by designating a keyword or object, the search result can be displayed more preferably. In addition, a desired image can be efficiently found from the displayed search result.

More specifically, a region in an image which corresponds to a feature designated as a search condition can be easily found from a search result, leading to an improvement in search operation efficiency. In addition, when candidate images as a result of a search are displayed in the form of a list, comparing partial images in the candidate images which satisfy a search condition makes it easy to determine which one of the candidate images is a desired image.

Furthermore, according to the present invention, the states of the details of a found region can be easily grasped, so the search operation efficiency can be improved.

Moreover, according to the present invention, when a plurality of search conditions are designated, the operator can easily grasp which object in a search result image corresponds to which search condition. This makes it possible to improve the search operation efficiency.

The present invention is not limited to the above embodiments and various changes and modification can be made within the spirit and scope of the present inventions. Therefore, to apprise the public of the scope of the present invention, the following claims are made.

What is claimed is:

1. An image search apparatus which searches for an image by using
image storage means for storing a plurality of images,
region information storage means for storing partial images included in the respective images stored in the image storage means in correspondence with the respective images, and
region feature storage means for storing features of the partial images stored in the region information storage means in correspondence with the partial images, comprising:
image feature designation means for designating a feature of a search target image;
candidate image determination means for searching features of partial images in the region feature storage means on the basis of the feature of the image which is designated by said image feature designation means, and determining an image which is made to correspond to a partial image obtained on the basis of a search result as a candidate image from the images stored in the image storage means; and
search result display means for displaying a reduced image of the candidate image determined by said candidate image determination means,
wherein said search result display means displays a reduced image of the candidate image upon enlarging the partial image included in the candidate image.

2. The apparatus according to claim 1, characterized in that when a plurality of candidate images are obtained on the basis of a search result, said search result display means displays reduced images of the plurality of candidate images in the form of a list.

3. An image search apparatus which searches for an image by using
image storage means for storing a plurality of images,
region information storage means for storing partial images included in the respective images stored in the image storage means in correspondence with the respective images, and
region feature storage means for storing features of the partial images stored in the region information storage means in correspondence with the partial images, comprising:
image feature designation means for designating a feature of a search target image;
candidate image determination means for searching features of partial images in the region feature storage means on the basis of the feature of the image which is designated by said image feature designation means, and determining an image which is made to correspond to a plurality of partial images obtained on the basis of a search result as a candidate image from the images stored in the image storage means; and
search result display means for displaying a reduced image of the candidate image determined by said candidate image determination means,
wherein said search result display means displays a reduced image of the candidate image upon enlarging the plurality of partial images included in the candidate image.

4. The apparatus according to claim 3, characterized in that said search result display means synthesizes the plurality of partial images to generate a new single partial image, and displays the new single partial image as a reduced image.

5. The apparatus according to claim 4, characterized in that said search result display means generates a new single partial image by synthesizing the plurality of partial images while a relative positional relationship between the plurality of partial images is kept.

6. The apparatus according to claim 3, characterized in that when the plurality of partial images partly overlap, said search result display means generates a new single partial image by synthesizing the plurality of partial images.

7. The apparatus according to claim 3, characterized in that sizes of the plurality of partial images are unified to a predetermined size.

8. An image search apparatus which searches for an image by using
image storage means for storing a plurality of images,
region information storage means for storing partial images included in the respective images stored in the image storage means in correspondence with the respective images, and
region feature storage means for storing features of the partial images stored in the region information storage means in correspondence with the partial images, comprising:
image feature designation means for designating a feature of a search target image;
candidate image determination means for searching features of partial images in the region feature storage means on the basis of the feature of the image which is designated by said image feature designation means, and determining an image which is made to correspond to a partial image obtained on the basis of a search result as a candidate image from the images stored in the image storage means; and
search result display means for displaying a reduced image of the candidate image determined by said candidate image determination means in a plurality of patterns.

9. The apparatus according to claim 8, characterized in that said search result display means displays the plurality of reduced images in the form of a list.

10. The apparatus according to claim 8, characterized in that said search result display means displays a reduced image of the candidate image.

11. The apparatus according to claim 8, characterized in that said search result display means displays a reduced image of the partial image used to determine the candidate image.

12. The apparatus according to claim 8, characterized in that said search result display means alternately displays the reduced images at the same position one by one in an automatic manner.

13. The apparatus according to claim 8, characterized in that
the apparatus further comprises switching means for switching display of the reduced images in said search result display means, and
said search result display means alternately displays the reduced images at the same position one by one on the basis of a switching instruction from said switching means.

14. The apparatus according to claim 1, characterized in that said search result display means displays the reduced image in an area with a predetermined size.

15. The apparatus according to claim 1, characterized in that the partial image comprises a rectangular image having a region surrounded by a circumscribed rectangle of a predetermined object region included in the image.

16. The apparatus according to claim 1, characterized in that said search result display means displays a reduced image of the candidate image while emphasizing the partial image included in the candidate image.

17. The apparatus according to claim 1, characterized in that the region feature storage means stores, as a feature of the image, at least one of concept information expressing a concept obtained from the partial image, language information expressing the concept in a language, an image feature expressing a feature of the partial image, and a combination of the concept information, the language information, and the image feature.

18. An image search method for an image search apparatus which can be connected to
an image storage unit which stores a plurality of images,
a region information storage unit which stores partial images included in the respective images stored in the image storage unit in correspondence with the respective images, and
a region feature storage unit which stores features of the partial images stored in the region information storage unit in correspondence with the partial images, comprising:
an image feature designation step of designating a feature of a search target image;
a candidate image determination step of searching features of partial images in the region feature storage unit on the basis of the designated feature of the image, and determining an image which is made to correspond to a partial image obtained on the basis of a search result as a candidate image from the images stored in the image storage unit; and
a search result display step of enlarging the partial image included in the determined candidate image and displaying a reduced image of the candidate image.

19. An image search method for an image search apparatus which can be connected to
an image storage unit which stores a plurality of images,
a region information storage unit which stores partial images included in the respective images stored in the image storage unit in correspondence with the respective images, and
a region feature storage unit which stores features of the partial images in the region information storage unit in correspondence with the partial images, comprising:
an image feature designation step of designating a feature of a search target image;
a candidate image determination step of searching features of partial images stored in the region feature storage unit on the basis of the designated feature of the image, and determining an image which is made to correspond to a plurality of partial images obtained on the basis of a search result as a candidate image from the images stored in the image storage unit; and
a search result display step of enlarging the plurality of partial images included in the determined candidate image and displaying a reduced image of the candidate image.

20. An image search method for an image search apparatus which can be connected to
an image storage unit which stores a plurality of images,
a region information storage unit which stores partial images included in the respective images stored in the image storage unit in correspondence with the respective images, and
a region feature storage unit which stores features of the partial images stored in the region information storage unit in correspondence with the partial images, comprising:
an image feature designation step of designating a feature of a search target image;
a candidate image determination step of searching features of partial images in the region feature storage unit on the basis of the designated feature of the image, and determining an image which is made to correspond to a partial image obtained on the basis of a search result as a candidate image from the images stored in the image storage unit; and
a search result display step of displaying a reduced image of the determined candidate image in a plurality of patterns.

21. A program for causing a computer, which can be connected to
an image storage unit which stores a plurality of images,
a region information storage unit which stores partial images included in the respective images stored in the image storage unit in correspondence with the respective images, and
a region feature storage unit which stores features of the partial images in the region information storage unit in correspondence with the partial images, to execute
an image feature designation step of designating a feature of a search target image;
a candidate image determination step of searching features of partial images in the region feature storage unit on the basis of the designated feature of the image, and determining an image which is made to correspond to a partial image obtained on the basis of a search result as a candidate image from the images stored in the image storage unit; and
a search result display step of enlarging the partial image included in the determined candidate image and displaying a reduced image of the candidate image.

22. A computer-readable recording medium storing a program defined in claim 21.
